(19) United States
(12) Patent Application Publication
(10) Pub. No.: US 2025/0382424 A1
(43) Pub. Date: Dec. 18, 2025

(54) PROCESS FOR MODIFYING THE MELTING CHARACTERISTICS OF A LIGNIN

(71) Applicant: TANOVIS AG, Rüschlikon (CH)

(72) Inventors: Alfred ABÄCHERLI, Lausanne (CH); David GHIDONI, Bussigny (CH)

(21) Appl. No.: 18/876,925

(22) PCT Filed: Jun. 23, 2023
(86) PCT No.: PCT/EP2023/067141

§ 371 Date: Dec. 19, 2024

(30) Foreign Application Priority Data
Jun. 24, 2022 (EP) 22181051.8

(51) Int. Cl. C08H 7/00

(52) U.S. Cl. CPC C08H 6/00

(57) ABSTRACT

The present invention is directed to a process for modifying the melting characteristics of a first lignin by chemically modifying the first lignin in a reactor under conditions of reduced temperature and increased pressure (e.g., greater than about one atmosphere). The process of modifying the melting characteristics of the first lignin can comprise (i) lowering the melting temperature of the first lignin; (ii) converting a partially meltable first lignin to a completely meltable second lignin; or (iii) reducing the melting viscosity of the first lignin.

The present invention relates to a process for modifying the melting characteristics of a first lignin, the process comprising reacting the first lignin with an alcohol in a reactor to produce a second (modified) lignin. The first lignin can be a partially melting lignin, a meltable lignin, a plasticized lignin, or a plasticizable lignin. The process of modifying the melting characteristics of the first lignin can include lowering the melting temperature of the first lignin, converting a partially melting first lignin to a completely meltable second lignin, and/or reducing the melting viscosity of the first lignin.

### RELATED ART

Lignocellulose refers to plant dry biomass, and is among the most abundantly available raw materials on earth. Lignocellulose comprises two main types of biopolymers, namely (i) cellulose and hemicellulose, and (ii) lignin. Lignin is a heterogenous biopolymer comprising crosslinked phenolic monomers, and is a component of all lignocellulosic plants, including hardwood, softwood, and agricultural plants (also called annual plants). The lignin content in these plants ranges from about 15% to 40%.

Lignin, especially melting lignin, has a number of industrial applications including as an additive in thermoplastics such as polyolefins, polyamide, polylactic acid, polyvinyl chloride, polystyrene, thermoplastic polyurethanes, thermoplastic starch, rubbers, latexes, poly caprolactone, polyhydroxyalkanoate, polyhydroxybutyrate and polyethylene terephthalate. When a melting lignin is added to thermoplastics, it preferably acts as a co-polymer and not as a filler, and thus a higher percentage of lignin can be added to the thermoplastic. Lignin (e.g., melting lignin) can also form composites with cellulose fibres or other fibre materials (e.g., wood fibres, hemp, and flax). When used in carbon fibres, the addition of a melting lignin allows melt spinning, which is more economic than other types of spinning. In such cases, a small amount of melting lignin can be added to non-melting lignin to soften the resulting carbon fibres enough to allow melt spinning. Melting lignins can also be used as a replacement for bitumen or asphalt. It was also found that for partial replacement of polyol for polyurethane forms a lignin treated according to the process of this invention gave better results in terms of the achievable amount of polyol replacement. Further applications are thermosetting resins (phenol-formaldehyde resins, polyesters, epoxies), adhesives for wood products and paperboard products, surface sizing and coating of paper and packaging materials, coatings on wood, paper, concrete, asphalt, plastic, glass, and metal.

There are generally two categories of industrial processes to separate lignin from lignocellulose. The pulping process, which produces pulping lignins, hydrolyses the lignin (and hemicellulose) of lignocellulose and leaves cellulose as a solid residue. The dissolved lignin is then separated from solid cellulose residue by filtration. The hydrolysis process, which produces hydrolysis lignins, hydrolyses the cellulose and hemicellulose of lignocellulose and leaves a lignin-rich product as a solid residue that can be isolated. Among the most typical pulping lignins are lignosulphonates, kraft lignins, soda lignins, and organosolv lignins.

Lignosulphonates are produced by the sulphite process involving sodium, ammonium, calcium or magnesium sulphite and sulphur dioxide in water. To purify the lignosulphonates, sugars are fermented into alcohol and the metal ion content can be reduced by membranes.

Kraft lignins result from the kraft process (the most important (e.g., most widely used) industrial process for isolating lignin), in which raw lignocellulose is heated in an aqueous solution of sodium sulphide and sodium hydroxide to hydrolyse and dissolve the lignin. The lignin is precipitated from the resulting liquid with acid. Membranes can be used to recover the lignin: Electrochemical acidification by electrodialysis or ultrafiltration.

Soda lignin is produced by pulping with sodium hydroxide in water (with optional addition of anthraquinone). The soda process is the predominant process used for chemical pulping of non-wood raw materials. The recovery of the lignin is performed with similar methods as for kraft lignin.

Organosolv lignins can be produced with a variety of organic solvents such as alcohols (preferably ethanol), alcohol water mixtures, formic acid, acetic acid, and/or dioxane. The lignin is recovered by evaporation of the solvent. To pulp softwood, sodium hydroxide is added to the organic solvent (typically ethanol and NaOH, or methanol and NaOH).

Other pulping processes include ionic liquids (IL), deep eutectic solvents (DES), the Phoenix process or the Bloom process. Prior to the extraction of the lignin, the lignocellulosic material can also be pre-treated with a variety of methods including steam explosion or treatment with hydrochloric acid. These pre-treatments can degrade or partially degrade the structure of lignocellulose and increase the accessibility of lignin.

Hydrolysis lignins can be hydrolysed with mineral acids, preferably hydrochloric acid (to prepare acid lignins) or with enzymes (to prepare enzymatic lignins). Hydrolysis lignins can also be pre-treated using the pre-treatment methods described above to degrade or partially degrade the structure of the lignocellulose. Preferably steam explosion or other steam treatments are used. In some preferred embodiments acid pre-treatment (preferably with hydrochloric acid) is used as a pre-treatment for enzymatic lignins. The lignin-rich residues of these processes contain also important quantities of non-hydrolysed cellulose and hemicellulose. In some cases, the lignin is insoluble in any solvent. In other cases, a part of the lignin is soluble and can be extracted with any adapted solvent, of which sodium hydroxide is the most obvious.

In order to ensure consistent and reproducible results when using lignin as an additive in industrial applications, the melting temperature of the crude lignin is preferably reduced. Many crude lignins are only partially meltable, which means that only a portion of the lignin melts and the remaining portion (e.g., the portion with a higher molar mass) stays in powder form. Other lignins are meltable, but only with the addition of a plasticizer (i.e., an unreacted chemical additive). For example, known plasticizers for kraft lignins include glycols, PEG dimethyl ether (e.g., PEGDM 250 and PEGDM 500) ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid.

Chemical modification (e.g., etherification and esterification) of lignins to reduce their melting temperatures is known, but such processes generally take place at elevated temperature (e.g., above 170° C.), and require significant excess of the reagent (e.g., a polyglycol such as PEG). For example, lignin can be reacted with PEG at lignin:PEG ratios of 1:2, 1:3 and 1:4 in a chemical reactor for 2 hours at 175° C. U.S. Pat. No. 7,678,358 teaches the acetylation of lignin to modify the melting characteristics of the lignin. Esterification of lignin with maleic and succinic anhydride by reactive extrusion is also known.

Accordingly, there is a need for methods that can produce melting lignins with consistent and predictable melting characteristics for use as additives in industrial applications that do not require elevated temperatures, long reaction time, and/or excess reagents.

### SUMMARY OF THE INVENTION

The present invention is directed to a process for modifying the melting characteristics of a first lignin.

In some preferred embodiments, the process of modifying the melting characteristics of the first lignin comprises (i) lowering the melting temperature of the first lignin; (ii) converting a partially meltable first lignin to a completely meltable second lignin; or (iii) reducing the melting viscosity of the first lignin.

In a first aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, a plasticized lignin, or a plasticizable lignin;
provided that when said alcohol is an aliphatic mono alcohol, said first lignin is meltable, partially meltable, or plasticized at a temperature of 160° C. or lower.

As set forth below and without wishing to be bound by theory, the inventive process works by chemically reacting a first lignin with an alcohol (e.g., a diol or glycol) in a reactor (preferably a high-shear reactor such as an extruder) preferably under increased pressure (e.g., greater than one atmosphere) to produce a chemically modified (e.g., etherified) lignin with modified melting characteristics. In preferred embodiments, the levels of torque and pressure present within the high-shear reactor cause the hydroxyl groups of a first lignin to be chemically modified, preferably etherified, by an alcohol reactant (preferably a diol). As set forth herein, when the parameters of torque and pressure were adjusted to produce lower shear stress, a lower percentage of the hydroxyl groups of the first lignin were chemically modified (e.g., etherified) compared to first lignins that were chemically modified under high-shear conditions. In preferred embodiments, even increasing variables such as temperature and residence time within the reactor do not compensate for the loss of high shear (i.e., conditions of low shear still lead to a lower percentage of chemically modified lignins, even when temperature and/or residence time are increased).

The inventive process thus produces chemically modified lignins with modified melting characteristics at lower temperatures and more quickly (i.e., with shorter residence times) than previously known processes for chemically modifying lignin. The inventive process also requires less alcohol (e.g., a diol or a glycol such as PEG) than previously known processes. The inventive process differs from other known processes for lowering the melting point of a lignin because the lignins produced are chemically modified and not simply mixed with a plasticizer to form a plasticized lignin. Moreover, because all or substantially all of the alcohol (e.g., glycol or diol) is reacted with lignin using the inventive process, there is no need to separate the modified lignin from the excess alcohol (e.g., diol) at the end of the reaction. Instead, the modified lignin can be recovered as a powder at the outlet of the reactor after cooling and grinding. This results in lower production costs than for previously known processes.

Additionally, the chemically modified lignins produced according to the inventive process herein have improved melting characteristics compared to lignins that are plasticized with (i.e., mixed with but not chemically modified by) the same alcohol (e.g., diol) reactants.

Additional features and advantages of the invention will be apparent to one of skill in the art upon reading the Detailed Description of the Invention, below.

### DESCRIPTION OF FIGURES

FIG. 1 is an exemplary schematic of the chemical structure of lignin.

FIG. 2 is the screw configuration of the double screw extruder used in Examples 2 and 3. In FIG. 2 the term “RSE” refers to a right-handed screw element; “SFV” refers to a single flight shovel element; “SFN” refers to a union element that connects the SFV and RSE elements; “RKB” refers to a right-handed kneading block; and “LKB” refers to a left-handed kneading block.

FIG. 3 is a schematic of an exemplary screw reactor that can be used to carry out the inventive process.

### DETAILED DESCRIPTION OF THE INVENTION

Unless defined otherwise, all technical and scientific terms used herein have the same meanings as commonly understood by one of ordinary skill in the art to which this invention belongs.

The term “aryl” refers to cyclic, aromatic hydrocarbon groups that have 1 to 2 aromatic rings, including monocyclic or bicyclic groups such as phenyl, biphenyl or naphthyl. A —C₆-C₁₀ aryl group contains between 6 and 10 carbon atoms. When containing two aromatic rings (bicyclic, etc.), the aromatic rings of the aryl group may be joined at a single point (e.g., biphenyl), or fused (e.g., naphthyl). The aryl group may be optionally substituted by one or more hydroxyl groups.

The inventive process relates to modifying the melting characteristics of a first lignin, wherein modifying the melting characteristics can include lowering the melting temperature of the first lignin; converting a partially meltable first lignin to a completely meltable second lignin; and/or reducing the melting viscosity of the first lignin.

Thus, in a first aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, a plasticized lignin, or a plasticizable lignin;
provided that when said alcohol is an aliphatic mono alcohol, said first lignin is meltable, partially meltable, or plasticized at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, a plasticized lignin, or a plasticizable lignin;
provided that when said alcohol is an aliphatic mono alcohol, said first lignin is meltable, partially meltable, plasticized or plasticizable at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, a plasticized lignin, or a plasticizable lignin;
provided that when said alcohol is an aliphatic mono alcohol, said first lignin is meltable, partially meltable, or plasticizable at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the second lignin has modified melting characteristics compared to the first lignin.

In one aspect, the present disclosure provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, or a plasticizable lignin;
provided that when said alcohol is an aliphatic mono alcohol, said first lignin is meltable, partially meltable, or plasticizable at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, or a plasticizable lignin;
provided that when said alcohol is an aliphatic mono alcohol, said first lignin is meltable or partially meltable at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin or a meltable lignin;
provided that when said alcohol is an aliphatic mono alcohol, said first lignin is meltable or partially meltable at a temperature of 160° C. or lower.

In one aspect, the present invention provides a process for modifying the melting characteristics of a first lignin, the process comprising:
reacting the first lignin and an alcohol in a reactor to produce a second lignin, wherein the alcohol is an aromatic alcohol, a diol, a polyglycol and/or a polyol and preferably wherein the alcohol has a molecular weight of at least 62 g/mol;
wherein the first lignin is a partially meltable lignin, a meltable lignin, or a plasticizable lignin.

In one aspect, the present invention provides a process for modifying the melting characteristics of a first lignin, the process comprising:
reacting the first lignin and an alcohol in a reactor to produce a second lignin, wherein the alcohol is not an aliphatic mono-alcohol and preferably wherein the alcohol has a molecular weight of at least 62 g/mol;
wherein the first lignin is a partially meltable lignin, a meltable lignin, or a plasticizable lignin.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein said first lignin is meltable, partially meltable, or plasticizable at a temperature of 160° C. or lower.

In one aspect, the present disclosure provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, or a plasticized lignin;
provided that when said alcohol is an aliphatic mono alcohol, said first lignin is meltable, partially meltable, or plasticized at a temperature of 160° C. or lower.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein the first lignin is a partially meltable lignin, a meltable lignin, or a plasticized lignin;
provided that when said alcohol is an aliphatic mono alcohol, said first lignin is meltable or partially meltable at a temperature of 160° C. or lower.

In one aspect, the present invention provides a process for modifying the melting characteristics of a first lignin, the process comprising:
reacting the first lignin and an alcohol in a reactor to produce a second lignin, wherein the alcohol is an aromatic alcohol, a diol, a polyglycol and/or a polyol and preferably wherein the alcohol has a molecular weight of at least 62 g/mol;
wherein the first lignin is a partially meltable lignin, a meltable lignin, or a plasticized lignin.

In one aspect, the present invention provides a process for modifying the melting characteristics of a first lignin, the process comprising:
reacting the first lignin and an alcohol in a reactor to produce a second lignin, wherein the alcohol is not an aliphatic mono-alcohol and preferably wherein the alcohol has a molecular weight of at least 62 g/mol;
wherein the first lignin is a partially meltable lignin, a meltable lignin, or a plasticized lignin.

In one aspect, the present invention provides a process for modifying the melting characteristics of a first lignin, the process comprising:
reacting the first lignin and an alcohol in a reactor to produce a second lignin, preferably wherein the alcohol has a molecular weight of at least 62 g/mol;
wherein said first lignin is meltable, partially meltable, or plasticized at a temperature of 160° C. or lower.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

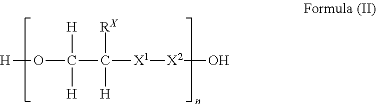

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

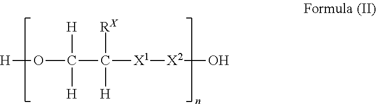

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

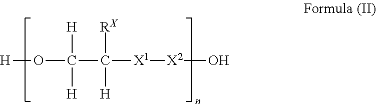

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

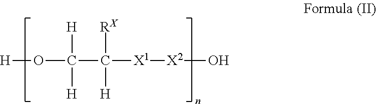

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

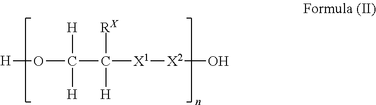

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress of said high-shear reactor is from about 100 N/m² to about 10,000 N/m²;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

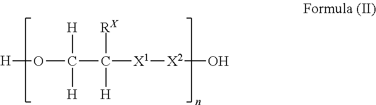

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress of said high-shear reactor is from about 100 N/m² to about 10,000 N/m²;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein a shear stress inside said high-shear reactor is from about 100 N/m² to about 10,000 N/m²;
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein a shear stress inside said high-shear reactor is from about 100 N/m² to about 10,000 N/m²;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aliphatic diol, an aromatic diol, or a diol of Formula (II):

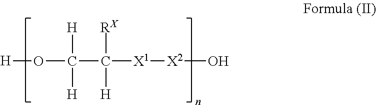

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is a diol of Formula (II):

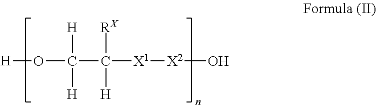

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aromatic diol;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aliphatic diol;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aliphatic diol, an aromatic diol, or a diol of Formula (II):

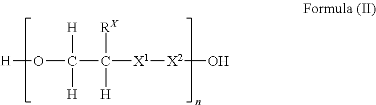

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is a diol of Formula (II):

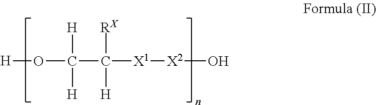

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aromatic diol;
wherein a shear stress inside said high-shear reactor is from about 100 N/m² to about 10,000 N/m²;
wherein said second lignin is chemically modified by said diol.

In one aspect, the present invention provides a process for modifying the melting characteristics of a first lignin, the process comprising:
reacting said first lignin with a diol in a high-shear reactor to produce a second lignin;
wherein said diol is an aliphatic diol;
wherein a shear stress inside said high-shear reactor is from about 100 N/m² to about 10,000 N/m²;
wherein said second lignin is chemically modified by said diol.

In some preferred embodiments, the process of modifying the melting characteristics of the first lignin comprises (i) lowering the melting temperature of the first lignin; (ii) converting a partially meltable first lignin to a completely meltable second lignin; or (iii) reducing the melting viscosity of the first lignin. In some preferred embodiments, the first lignin is a lignin melting at a temperature above the melting temperature of the second lignin.

In another aspect, the present invention provides a modified lignin comprising a structural unit of the formula (I):

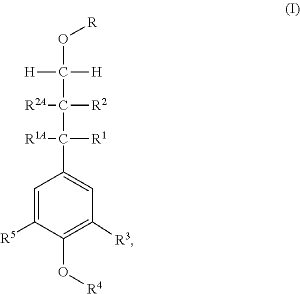

wherein:
R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
n is an integer from 1 to 10,000;
R^{A} and R^{B} are each independently H or C₁-C₆ alkyl;
R^{1A} is H and R¹ is independently selected from —H, —OH, —O-lignin polymer residue, lignin polymer residue, and a carbohydrate; or R^{1A} and R¹ combine together with the carbon atom to which they are attached to form a carbonyl group;
R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
R³ is independently selected from —H, —OCH₃, and lignin polymer residue;
R⁴ is independently selected from —H and lignin polymer residue; and
R⁵ is independently selected from —H, —OCH₃, and lignin polymer residue.

In one aspect, the present invention provides a modified lignin produced by a process according to the method as described herein.

### Alcohols

The inventive process comprises reacting (preferably etherifying) a first lignin with an alcohol in a reactor to produce a second (modified) lignin. As used herein, the term “alcohol” is understood to mean an organic compound comprising a hydroxyl group (—OH) bonded to a carbon atom, wherein the remaining bonds to the carbon atom are C or H. An alcohol can comprise a single hydroxyl group or can comprise more than one hydroxyl groups (e.g., two, three or four hydroxyl groups).

In preferred embodiments, the alcohol has a molecular weight of at least 62 g/mol. Without wishing to be bound by theory, use of alcohols with lower molecular weights (e.g., methanol, ethanol, propanol) can lead to increased risk of explosion when used with the inventive process and as such alcohols are not preferred.

In some embodiments, the alcohol is an aliphatic alcohol. An aliphatic alcohol as used herein is understood as an alcohol in which the hydroxyl group is bonded to a saturated hydrocarbon (i.e., an alkyl residue) or an unsaturated hydrocarbon (e.g., an alkene or alkyne residue). The hydrocarbon group is branched or unbranched. In some embodiments, the alcohol has one hydroxyl group and is termed a “mono alcohol” or “aliphatic mono alcohol.” In some embodiments the hydroxy group is bonded at a terminal end of the hydrocarbon (e.g., 1-butanol; 1-pentanol; 1-hexanol). In some embodiments the hydroxy group is bonded at an internal carbon of the hydrocarbon (e.g., 2-butanol; 2-pentaol; 3-pentanol). In some embodiments, the aliphatic alcohol (e.g., aliphatic mono alcohol) comprises 4, 5, 6, 7, 8, 9, 10, 11, 12, 13, 14, 15, 16, 17, 18, 19 or 20 carbon atoms; preferably the aliphatic alcohol comprises 4, 5, 6, 7, 8, 9, 10, 11, 12, 13, 14 or 15 carbon atoms, more preferably 4, 5, 6, 7, 8, 9 or 10 carbon atoms, yet more preferably 4 or 5 carbon atoms.

In some embodiments, the alcohol is an aromatic alcohol. An aromatic alcohol as used herein is understood as an alcohol in which the hydroxyl group (—OH) is bonded to an aryl or aromatic ring (e.g., phenol) or fused aryl or aromatic rings (e.g., 2-naphthol). In preferred embodiments, the aromatic alcohol comprises one, two or three fused aromatic rings, preferably one or two fused aromatic rings, more preferably one aromatic ring. In some embodiments the aromatic alcohol has more than one hydroxy group, preferably two hydroxy groups.

In some preferred embodiments, the alcohol is a diol. The term “diol” as used herein is interchangeable with the term “glycol.” A diol or glycol is understood as an organic compound comprising at least two, i.e., two or more hydroxyl groups, wherein the hydroxyl groups are bonded to different carbon atoms. In some embodiments, the remaining bonds to the carbon atoms are C or H.

In some preferred embodiments, the diol is an aliphatic diol. An aliphatic diol is understood as a diol in which the two or more, e.g., both hydroxyl groups are bonded to the same saturated hydrocarbon or the same unsaturated hydrocarbon. In preferred embodiments said hydrocarbon is a saturated hydrocarbon. The hydrocarbon groups are branched or unbranched. In preferred embodiments, the hydroxyl groups are bonded to different carbon atoms within the hydrocarbon. In some embodiments said alcohol is a diol comprising two hydroxyl groups wherein said two hydroxyl groups are bonded at terminal carbon atoms (e.g., ethylene glycol; 1,3-propanediol; 1,4-butanediol; 1,5-pentanediol; 1,6-hexanediol; 1,7-heptanediol; 1,8-octanediol; 1,9-nonanediol; 1,10-decanediol). In some preferred embodiments, at least one of the hydroxyl groups is bonded at an internal carbon atom of the hydrocarbon (e.g., 1,2-propanediol; 2,3-butanediol).

In some embodiments, the aliphatic diol comprises 2, 3, 4, 5, 6, 7, 8, 9, 10, 11, 12, 13, 14, 15, 16, 17, 18, 19 or 20 carbon atoms; preferably the aliphatic diol comprises 2, 3, 4, 5, 6, 7, 8, 9, 10, 11, 12, 13, 14 or 15 carbon atoms, more preferably 2, 3, 4, 5, 6, 7, 8, 9 or 10 carbon atoms, yet more preferably 2, 3, 4 or 5 carbon atoms.

In some embodiments, said aliphatic diol comprises at least two, e.g., two or more hydroxyl groups and does not comprise further substitution. The aliphatic diol is branched or unbranched. Preferably the aliphatic diol comprises an unbranched (i.e., linear) alkyl chain, more preferably wherein the hydroxy groups are bonded at the terminal carbon atoms.

In some embodiments, the aromatic alcohol is an aromatic diol. As used herein, an aromatic diol is an aromatic alcohol comprising at least two, i.e., two or more hydroxyl groups, (e.g., 2,3-dihydroxynaphthalene; benzene 1,2-diol; benzene 1,3-diol; benzene 1,4-diol). In some embodiments, the diol is a C₆-C₁₀ aromatic diol. In some preferred embodiments, the diol is a C₆ aromatic diol. In some preferred embodiments, the aromatic diol is a C₁₀ aromatic diol. In some embodiments, said aromatic diol comprises two hydroxyl groups and does not comprise further substitution. In some embodiments, said aromatic diol comprises two hydroxyl groups and comprises further substitution, preferably wherein said further substitution comprises additional hydroxyl groups. Thus, in some embodiments, an aromatic diol can comprise more than two hydroxyl groups, e.g., can comprise 3, 4, 5 or 6 hydroxyl groups.

In some preferred embodiments, the alcohol is a diol wherein said diol is a glycol or polyglycol. In some embodiments, the glycol is ethylene glycol. In some embodiments, the glycol is diethylene glycol (DEG). In some embodiments, the glycol is triethylene glycol (TEG). In some embodiments, the glycol is tetraethylene glycol (TTEG). In some embodiments, the glycol is pentaethylene glycol. In some embodiments, the glycol is hexaethylene glycol (HEG). In some embodiments, the glycol is mono propylene glycol, dipropylene glycol, tripropylene glycol, tetraproylene glycol, pentapropylene glycol, or hexapropylene glycol.

In some embodiments, said alcohol is an alcohol of Formula (II):

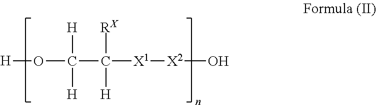

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000, preferably n is any integer from 1 to 1,000, more preferably n is any integer from 1 to 10.

In preferred embodiments of Formula (II), R^{X2} is selected from —H and —C₁-C₄ alkyl.

In preferred embodiments of Formula (II), when X² is a chemical bond, R^{X1} is not —OH.

In preferred embodiments of Formula (II), when X¹ and X² are chemical bonds, R^{X} is not —OH.

In some embodiments, said alcohol is an alcohol of Formula (II):

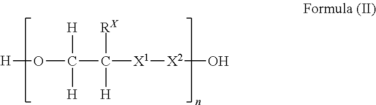

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H and —C₁-C₄ alkyl; and
n is any integer from 1 to 10,000, preferably n is any integer from 1 to 1,000, more preferably n is any integer from 1 to 10.

In preferred embodiments, when X² is a chemical bond, R^{X1} is not —OH.

In preferred embodiments, when X¹ and X² are chemical bonds, R^{X} is not —OH.

In some embodiments, said alcohol is an alcohol of Formula (II):

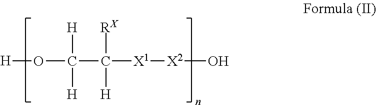

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl, and —OH;
R^{X1} is independently, at each occurrence, selected from —H, —C₁-C₂ alkyl, and —OH;
R^{X2} is independently, at each occurrence, selected from —H, —C₁-C₂ alkyl, and —OH; and
n is any integer from 1 to 10,000, preferably n is any integer from 1 to 1,000, more preferably n is any integer from 1 to 10.

In some embodiments, said alcohol is an alcohol of Formula (II):

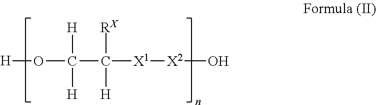

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl, and —OH;
R^{X1} is independently, at each occurrence, selected from —H, —C₁-C₂ alkyl, and —OH;
R^{X2} is independently, at each occurrence, selected from —H and —C₁-C₂ alkyl; and
n is any integer from 1 to 10,000, preferably n is any integer from 1 to 1,000, more preferably n is any integer from 1 to 10. In preferred embodiments, when X² is a chemical bond, R^{X1} is not —OH. In preferred embodiments, when X¹ and X² are chemical bonds, R^{X} is not —OH.

In some embodiments, said alcohol is an alcohol of Formula (II):

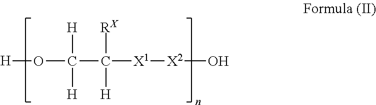

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl, and —OH;
R^{X1} is independently, at each occurrence, selected from —H and —OH;
R^{X2} is independently, at each occurrence, selected from —H and —OH, preferably R^{X2} is —H; and
n is any integer from 1 to 10,000, preferably n is any integer from 1 to 1,000, more preferably n is any integer from 1 to 10. In preferred embodiments, when X² is a chemical bond, R^{X1} is not —OH. In preferred embodiments, when X¹ and X² are chemical bonds, R^{X} is not —OH.

In some embodiments, said alcohol is an alcohol of Formula (II):

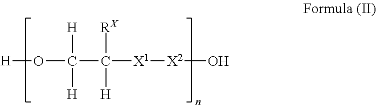

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl, and —OH;
R^{X1} is independently, at each occurrence, selected from —H and —C₁-C₂ alkyl;
R^{X2} is independently, at each occurrence, selected from —H and —C₁-C₂ alkyl; and
n is any integer from 1 to 10,000, preferably n is any integer from 1 to 1,000, more preferably n is any integer from 1 to 10.

In some embodiments, said alcohol is an alcohol of Formula (II):

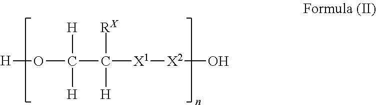

wherein:
X¹ is independently, at each occurrence, selected from a chemical bond and —CHR^{X1}—;
X² is a chemical bond;
R^{X} is independently, at each occurrence, selected from —H, —C₁-C₂ alkyl and —OH;
R^{X1} is independently, at each occurrence, selected from —H, —C₁-C₂ alkyl and —OH;
n is any integer from 1 to 10,000, preferably n is any integer from 1 to 1,000, more preferably n is any integer from 1 to 10.

In some embodiments, said alcohol is an alcohol of Formula (II):

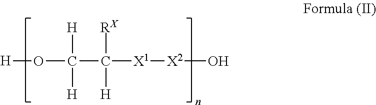

wherein:
X¹ is independently, at each occurrence, selected from a chemical bond and —CHR^{X1}—;
X² is a chemical bond;
R^{X} is independently, at each occurrence, selected from —H, —C₁-C₂ alkyl and —OH;
R^{X1} is independently, at each occurrence, selected from —H and —C₁-C₂ alkyl;
n is any integer from 1 to 10,000, preferably n is any integer from 1 to 1,000, more preferably n is any integer from 1 to 10. In some embodiments, when X¹ is a chemical bond, R^{X} is not OH.

In some embodiments, said alcohol is an alcohol of Formula (II):

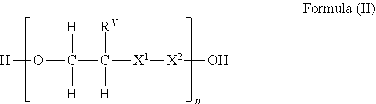

wherein:
X¹ is a chemical bond;
X² is a chemical bond;
R^{X} is independently, at each occurrence, selected from —H, —C₁-C₂ alkyl and —OH;
n is any integer from 1 to 10,000, preferably n is any integer from 1 to 1,000, more preferably n is any integer from 1 to 10.

In some embodiments, said alcohol is an alcohol of Formula (II):

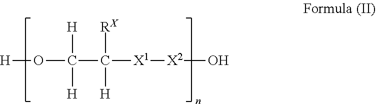

wherein:
X¹ is a chemical bond;
X² is a chemical bond;
R^{X} is independently, at each occurrence, selected from —H and —C₁-C₂ alkyl;
n is any integer from 1 to 10,000, preferably n is any integer from 1 to 1,000, more preferably n is any integer from 1 to 10.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is 1.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H and —C₁-C₄ alkyl; and
n is 1. In preferred embodiments, when X² is a chemical bond, R^{X1} is not —OH. In preferred embodiments, when X¹ and X² are chemical bonds, R^{X} is not —OH.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl and —OH;
R^{X1} is independently, at each occurrence, selected from —H, —C₁-C₂ alkyl and —OH;
R^{X2} is independently, at each occurrence, selected from —H, —C₁-C₂ alkyl and —OH; and
n is 1.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₂ alkyl and —OH;
R^{X1} is independently, at each occurrence, selected from —H, —C₁-C₂ alkyl and —OH;
R^{X2} is independently, at each occurrence, selected from —H and —C₁-C₂ alkyl; and
n is 1. In preferred embodiments, when X² is a chemical bond, R^{X1} is not —OH. In preferred embodiments, when X¹ and X² are chemical bonds, R^{X} is not —OH.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H and —OH;
R^{X1} is independently, at each occurrence, selected from —H and —OH;
R^{X2} is independently, at each occurrence, selected from —H and —OH; and
n is 1.

In some embodiments, said alcohol is an alcohol of Formula (II), wherein
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H and —OH;
R^{X1} is independently, at each occurrence, selected from —H and —OH;
R^{X2} is independently, at each occurrence, —H; and
n is 1.

In some embodiments, said alcohol is selected from:
ethylene glycol, diethylene glycol, glycerol, butane 1,2,3,4-tetrol, polyethylene glycol, propylene glycol, dipropylene glycol, polypropylene glycol, and polybutylene glycol.

In some embodiments, the alcohol is glycol wherein said glycol is a polyglycol. As used herein, a polyglycol is a diol with the generic formula HO—(CHR^{A}—CHR^{B}—O)ₙ—H, wherein R^{A} and R^{B} are each independently H or C₁-C₆ alkyl; and wherein n is an integer from 1 to 10,000. In some preferred embodiments, n is 1. In some preferred embodiments, n is 2. In some preferred embodiments, n is 3. In some preferred embodiments, n is 4. In some preferred embodiments, n is 5. In some preferred embodiments, n is 6. In some preferred embodiments, n is 7. In some preferred embodiments, n is 8. In some preferred embodiments, n is 9. In some preferred embodiments, n is 10.

In preferred embodiments, R^{A} is H and R^{B} is H or C₁-C₆ alkyl. In more preferred embodiments, R^{A} is H and R^{B} is H or C₁-C₂ alkyl. In yet more preferred embodiments, R^{A} is H and R^{B} is H or methyl. In yet more preferred embodiments, R^{A} and R^{B} are H.

In some preferred embodiments, n is 1; R^{A} is H; and R^{B} is H or methyl, preferably H. In some preferred embodiments, n is 2; R^{A} is H; and R^{B} is H or methyl, preferably H. In some preferred embodiments, n is 3; R^{A} is H; and R^{B} is H or methyl, preferably H. In some preferred embodiments, n is 4; R^{A} is H; and R^{B} is H or methyl, preferably H. In some preferred embodiments, n is 5; R^{A} is H; and R^{B} is H or methyl, preferably H. In some preferred embodiments, n is 6; R^{A} is H; and R^{B} is H or methyl, preferably H. In some preferred embodiments, n is 7; R^{A} is H; and R^{B} is H or methyl, preferably H. In some preferred embodiments, n is 8; R^{A} is H; and R^{B} is H or methyl, preferably H. In some preferred embodiments, n is 9; R^{A} is H; and R^{B} is H or methyl, preferably H. In some preferred embodiments, n is 10; R^{A} is H; and R^{B} is H or methyl, preferably H.

In preferred embodiments, the glycol is a polyglycol. In preferred embodiments, the polyglycol is a polyethylene glycol (PEG), a polypropylene glycol (PPG), or a polybutylene glycol (PBP); preferably a polyethylene glycol or a polypropylene glycol, yet more preferably a polyethylene glycol.

In preferred embodiments, the polyglycol (preferably PEG or PPG) has a molecular weight between about 300 g/mol and about 10,000 g/mol. In some embodiments, the polyglycol (preferably PEG or PPG) has a molecular weight between about 300 g/mol and about 5,000 g/mol. In some embodiments, the polyglycol (preferably PEG or PPG) has a molecular weight between about 300 g/mol and about 1,000 g/mol. In some embodiments, the polyglycol (preferably PEG or PPG) has a molecular weight between about 300 g/mol and about 900 g/mol. In some embodiments, the polyglycol (preferably PEG or PPG) has a molecular weight between about 300 g/mol and about 800 g/mol. In some embodiments, the polyglycol (preferably PEG or PPG) has a molecular weight between about 300 g/mol and about 700 g/mol. In some embodiments, the polyglycol (preferably PEG or PPG) has a molecular weight between about 300 g/mol and about 600 g/mol. In some embodiments, the polyglycol (preferably PEG or PPG) has a molecular weight between about 300 g/mol and about 500 g/mol. In some embodiments, the polyglycol (preferably PEG or PPG) has a molecular weight between about 300 g/mol and about 400 g/mol. In preferred embodiments, the polyglycol (preferably PEG or PPG, more preferably PEG) has a molecular weight of about 400 g/mol. In preferred embodiments, the polyglycol (preferably PEG or PPG, more preferably PEG) has a molecular weight of about 800 g/mol. In preferred embodiments, the polyglycol (preferably PEG or PPG, more preferably PEG) has a molecular weight of about 1200 g/mol.

In some embodiments, the polyglycol is PPG, and said PPG has a molecular weight of about 400 g/mol, about 725 g/mol, about 1,000 g/mol, about 2,000 g/mol, about 2,700 g/mol, or about 4,000 g/mol.

One of skill in the art will understand that PEG can be prepared in a wide variety of molecular weights, all of which are contemplated by the present disclosure. Moreover, one of skill in the art will understand that, as a polymer, even purified compositions of PEG do not necessarily all comprise the exact same molecular weight or number of repeating oxyethylene groups. Instead, compositions of PEG can typically comprise a range of average molecular weights and can be characterized by an average number of repeating oxyethylene groups “m.”

For example, the Handbook of Pharmaceutical Excipients, Sixth Edition, R. C. Rowe, P. J. Sheskey, M. E. Quinn, Pharmaceutical Press (2009), teaches the following common PEG polymers, which is not to be understood as an exhaustive list.

| Grade | m | Average Molecular Weight |
|---|---|---|
| PEG 200 | 4.2 | 190-210 |
| PEG 300 | 6.4 | 285-315 |
| PEG 400 | 8.7 | 380-420 |
| PEG 540 (blend) | — | 500-600 |
| PEG 600 | 13.2 | 570-613 |
| PEG 900 | 15.3 | 855-900 |
| PEG 1000 | 22.3 | 950-1050 |
| PEG 1450 | 32.5 | 1,300-1,600 |
| PEG 1540 | 28.0-36.0 | 1,300-1,600 |
| PEG 2000 | 40.0-50.0 | 1,800-2,200 |
| PEG 3000 | 60.0-75.0 | 2,700-3,300 |
| PEG 3350 | 75.7 | 3,000-3,700 |
| PEG 4000 | 69.0-84.0 | 3,000-4,800 |
| PEG 4600 | 104.1 | 4,400-4,800 |
| PEG 8000 | 181.4 | 7,000-9,000 |

In some embodiments, said alcohol is PEG, wherein said PEG is selected from PEG 200, PEG 300, PEG 400, PEG 540, PEG 600, PEG 900, PEG 1000, PEG 1450, PEG 1540, PEG 2000, PEG 3000, PEG 3350, PEG 4000, PEG 4600, and PEG 8000. In some embodiments, said alcohol is PEG 200. In some embodiments, said alcohol is PEG 300. In some embodiments, said alcohol is PEG 400. In some embodiments, said alcohol is PEG 540. In some embodiments, said alcohol is PEG 600. In some embodiments, said alcohol is PEG 900. In some embodiments, said alcohol is PEG 1000. In some embodiments, said alcohol is PEG 1450. In some embodiments, said alcohol is PEG 1540. In some embodiments, said alcohol is PEG 2000. In some embodiments, said alcohol is PEG 3000. In some embodiments, said alcohol is PEG 3350. In some embodiments, said alcohol is PEG 4000. In some embodiments, said alcohol is PEG 4600. In some embodiments, said alcohol is PEG 8000.

In some embodiments, the alcohol or diol is a polyol, understood herein as a compound comprising three or more hydroxy groups. In some embodiments, the polyol is glycerol.

In some embodiments the alcohol comprises a mixture of alcohols. For example, in some embodiments, the inventive process uses a mixture of an aliphatic alcohol, a glycol, an aromatic alcohol or aromatic diol, and/or a polyglycol.

In some preferred embodiments, the alcohol is selected from an aliphatic mono alcohol, an aromatic diol, an aliphatic diol, a polyol, and a polyglycol; preferably wherein the aliphatic diol is selected from mono ethylene glycol, 1,3-propanediol, 1,4-butanediol, 1,5-pentanediol, and 1,6-hexanediol; preferably wherein the polyglycol is glycerol; and preferably wherein the polyglycol is selected from diethylene glycol, triethylene glycol, tetraethylene glycol, pentaethylene glycol, hexaethylene glycol, polyethylene glycol, or polypropylene glycol, more preferably wherein said polyethylene glycol has a molecular weight of about 400 g/mol, 800 g/mol or 1200 g/mol, and wherein said polypropylene glycol has a molecular weight of about 400 g/mol, 725 g/mol, 1,000 g/mol, or 2,000 g/mol; or a combination thereof.

In some preferred embodiments, the alcohol is selected from an aromatic diol, an aliphatic diol, a polyol, and a polyglycol; preferably wherein the aliphatic diol is selected from mono ethylene glycol, 1,3-propanediol, 1,4-butanediol, 1,5-pentanediol, and 1,6-hexanediol; preferably wherein the polyglycol is glycerol; and preferably wherein the polyglycol is selected from diethylene glycol, triethylene glycol, tetraethylene glycol, pentaethylene glycol, hexaethylene glycol, polyethylene glycol, or polypropylene glycol, more preferably wherein said polyethylene glycol has a molecular weight of about 400 g/mol, 800 g/mol or 1200 g/mol, and wherein said polypropylene glycol has a molecular weight of about 400 g/mol, 725 g/mol, 1,000 g/mol, or 2,000 g/mol; or a combination thereof.

Without wishing to be bound, aliphatic mono alcohols do not plasticize with lignins. Accordingly, in preferred embodiments, when using an aliphatic mono alcohol as the alcohol, the lignin is meltable, partially meltable or plasticized at about 160° C. or lower.

In preferred embodiments, at least about 5% of the alcohol (preferably diol) reacts chemically with the first lignin to produce a chemically modified (preferably etherified) second lignin. In preferred embodiments, at least 10% of the alcohol (preferably a diol) reacts chemically with the first lignin, preferably to produce a chemically modified (preferably etherified) second lignin. In preferred embodiments, about 5% to about 100% of the alcohol (preferably diol) reacts chemically with the first lignin to produce a chemically modified (preferably etherified) second lignin. In preferred embodiments, about 10% to about 100%, preferably about 15% to about 100%; about 20% to about 100%; about 25% to about 100%; about 30% to about 100%; about 35% to about 100%; about 40% to about 100%; about 45% to about 100%; about 50% to about 100%; about 55% to about 100%; about 60% to about 100%; about 65% to about 100%; about 70% to about 100%; about 75% to about 100%; about 80% to about 100%; about 85% to about 100%; or about 90% to about 100% of the alcohol (preferably diol) reacts chemically with the first lignin to produce a chemically modified (preferably etherified) second lignin. In preferred embodiments, about 25% to about 95%, preferably about 25% to about 90%, about 25% to about 80%, or about 25% to about 70% of the alcohol (preferably a diol) reacts chemically with the first lignin to produce a chemically modified (preferably etherified) second lignin. In preferred embodiments, about 40% to about 95%, preferably about 40% to about 90%, about 40% to about 80%, or about 40% to about 70% of the alcohol (preferably a diol) reacts chemically with the first lignin to produce a chemically modified (preferably etherified) second lignin. In preferred embodiments, about 50% to about 95%, preferably about 50% to about 90%, about 50% to about 80%, or about 50% to about 70% of the alcohol (preferably a diol) reacts chemically with the first lignin to produce a chemically modified (preferably etherified) second lignin.

### First Lignins and Feedstocks

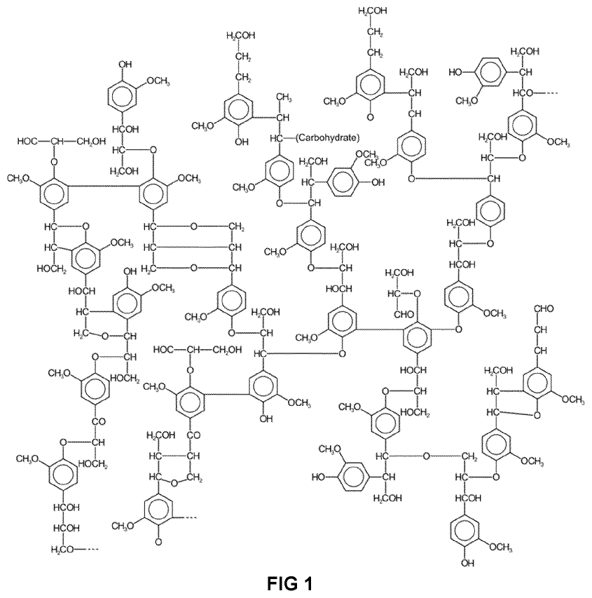

Lignin is a biopolymer comprising lignol monomers, the majority of which are paracoumaryl alcohol, coniferyl alcohol, and sinapyl alcohol as shown in FIG. 1. Because lignin occurs as a heterogenous polymer in nature and is isolated using a variety of different methods as outlined above, different samples of lignin can have different melting characteristics.

A variety of lignin feedstocks (e.g., crude lignins) can be used in the inventive process as the first lignin. In preferred embodiments, the first lignin must be at least partially meltable (i.e., meltable or partially meltable). Without wishing to be bound, non-meltable and/or non-plasticizable lignins (for example the lignin produced by the company Avantium™ or some high-molecular lignosulphonates) are not preferred first lignins for the inventive process, because the first lignin must at least partially melt in order for enough of the first lignin to come into contact with the alcohol and to react with the alcohol. Without wishing to be bound, when the first lignin is a non-melting and/or non-plasticizable lignin, not enough of the non-melting and/or non-plasticizable lignin is capable of coming into contact with an alcohol enough to react with the alcohol.

Melting is understood to mean the process wherein at least a portion of a lignin sample turns from a solid (e.g., powder) form to a liquid form. Without wishing to be bound, a melted lignin can have a range of consistencies. For example, the melted portion of a melted lignin can be a free-flowing (e.g., low-viscosity) liquid or a highly viscous liquid. Preferably, the melted portion of a melted lignin has a viscosity of about 0.5 to about 10,000 mPa·s, preferably about 1 to about 5,000, more preferably about 1 to about 2,000 mPa·s at the melting temperature. In preferred embodiments, the melted portion of a melted lignin has a viscosity of about 1 to about 500 mPa·s at the melting temperature.

Thus, in preferred embodiments, the first lignin is a partially meltable lignin, a meltable lignin, a plasticized lignin, or a plasticizable lignin. In yet more preferred embodiments, the first lignin is a partially meltable lignin, a meltable lignin, or the first lignin can be plasticized to become a partially meltable lignin or a meltable lignin. As described in Example 1, a “partially melting lignin” and/or a “meltable lignin” can be determined by the Hot Plate Method. The Hot Plate Method comprises placing a sample of lignin on a hot plate at a constant temperature and triturating the sample manually with an iron spatula. The melting characteristics of the lignin sample are observed visually and assigned a pre-determined value between 0 and 4 (first embodiment) or between 0 and 5 (second embodiment) for each temperature of the hot plate. Preferably, the melting characteristics of the lignin sample are tested at a temperature of about 140° C., about 160° C., about 180° C., or about 210° C.; more preferably at a temperature of about 210° C.

As used herein, a “partially melting lignin” is a lignin in which only a portion of the lignin melts and the remaining portion (e.g., the portion with a higher molar mass) stays in solid (e.g., powder) form. In some embodiments, the portion of the partially melting lignin that does not melt burns or chars. In preferred embodiments, the melting portion of the partially melting lignin melts at temperatures above room temperature (e.g., above about 25° C.) at one atmosphere of pressure. In some embodiments, the partially melting lignin is not mixed with a plasticizer (i.e., not a plasticized lignin).

In preferred embodiments, a “partially melting lignin” is understood herein as a lignin that softens when tested using the Hot Plate Method as detected by the ability to deform the lignin using the iron spatula. However, the partially melting lignin does not fully melt, in contrast to a “meltable lignin.” In preferred embodiments, a “partially melting lignin” is a lignin that obtains a score of 3 by the Hot Plate Method as defined in Example 1 (second embodiment using 1-5 scale), preferably wherein the Hot Plate Method (second embodiment) is carried out at a temperature of about 140° C., about 160° C., about 180° C., or about 210° C.; more preferably at a temperature of about 210° C.

As used herein, a “meltable lignin,” also referred to herein as a “melting lignin,” is a lignin that is capable of melting completely. In preferred embodiments, the melting lignin or meltable lignin melts completely at temperatures above room temperature (e.g., above about 25° C.) at one atmosphere of pressure. In some embodiments, the meltable lignin is not mixed with a plasticizer (i.e., not a plasticized lignin).

In preferred embodiments, a “meltable lignin” is a lignin that obtains a score of 4 or higher by the Hot Plate Method (second embodiment using 1-5 scale) as defined in Example 1, preferably wherein the Hot Plate Method (second embodiment) is carried out at a temperature of about 140° C., about 160° C., about 180° C., or about 210° C.; more preferably at a temperature of about 210° C. As used herein, the melting lignin or partially melting lignin can be a plasticized lignin. A “plasticized lignin” is a type of melting or partially melting lignin as defined herein that is mixed with, but not chemically bonded to, a plasticizer (i.e., an unreacted chemical additive). The plasticizer can be any plasticizer defined herein. The plasticization process lowers the melting temperature of a melting lignin or partially melting lignin and/or transforms a previously non-melting lignin (e.g., at a given temperature) into a melting lignin or a partially melting lignin (e.g., at the same temperature) and/or transforms a previously partially melting lignin at a given temperature into a melting lignin at the same temperature. As used herein a plasticizer can include aromatic alcohols (including aromatic diols), aliphatic diols, polyglycols and/or polyols (e.g., glycerol). In preferred embodiments the reactants (i.e., alcohols, preferably diols) are themselves plasticizers which improve the melting behaviour of a first lignin already before the reaction. However, by the reaction (e.g., etherification of the lignin by the alcohol), the melting behaviour is further improved, and the plasticizing reactant is fixed to the lignin which has the advantage of preventing migration, leaking, and leaching of the plasticizer. Without wishing to be bound, aliphatic mono alcohols are not able to plasticize lignins and are therefore not considered plasticizers. In some embodiments, an alcohol (e.g., an aromatic alcohol including aromatic diols, aliphatic diols, polyglycols and/or polyols such as glycerol) can be used both as a plasticizer and as an alcohol (i.e., reagent) in the inventive process. In some embodiments, the first lignin is a melting lignin or partially melting lignin without the addition of a plasticizer. In some embodiments, the first lignin is a melting lignin or partially melting lignin because of the addition of a plasticizer.

As used herein, a “plasticizable lignin” is a non-melting lignin that does not comprise a plasticizer but is capable of being plasticized and thus capable of becoming a melting lignin or a partially melting lignin as defined herein. In some embodiments, a plasticizable lignin is a non-melting lignin that is capable of being converted to a meltable or a partially meltable lignin as defined herein by the addition of a plasticizer. The plasticizer can be any plasticizer defined herein. In some embodiments, a plasticizable lignin is a melting or partially melting lignin whose melting temperature is capable of being lowered by the addition of a plasticizer.

In some embodiments, the first lignin is a plasticizable lignin (preferably a non-melting plasticizable lignin) that is plasticized during the inventive process, preferably when the plasticizable lignin is combined with a plasticizer (preferably a diol such as DEG; wherein the plasticizer is not a mono alcohol) inside a reactor (preferably a high-shear reactor, e.g., a screw reactor, preferably a screw extruder or twin-screw extruder). Without wishing to be bound, the plasticization process lowers the melting temperature of the plasticizable (first) lignin to enable further reaction by the inventive process. Thus, in some embodiments, the plasticizable lignin is both plasticized and chemically modified by subjecting the plasticizable lignin to the inventive process.

As used herein, a “non-melting lignin” is a lignin that does not melt even when exposed to high temperatures. In preferred embodiments, a non-melting lignin chars or burns at high temperature (e.g., above 210° C.) instead of melting. Preferably, a “non-melting lignin” is a lignin that does not obtain a score of 3 or higher when tested using the Hot Plate Method (second embodiment; 1-5 scale) at a temperature of 210° C. Without wishing to be bound by theory, non-melting lignins (or portions thereof) are typically characterized by higher molar mass than melting lignins and/or different chemical structure (e.g., increased condensation between the phenylpropane units).

As used herein, the “first lignin” is preferably derived from any naturally-occurring or non-naturally occurring source of lignin. In preferred embodiments, the first lignin is derived from any species of softwood, hardwood, or non-wood plant. In more preferred embodiments, the first lignin is derived from any species of softwood or non-wood plant. In some embodiments, the first lignin is derived from a softwood plant. In some embodiments, the first lignin is derived from a non-wood plant. In some embodiments, the first lignin is not derived from a hardwood plant. Exemplary non-wood plants include agricultural residues such as bagasse, straw (e.g., wheat, barley, rice), corn stalks, cultivated plants (e.g., hemp, flax, kenaf, sisal, abaca, miscanthus, sorghum, bamboo), and wild-growing plants (e.g., elephant grass, sarkanda).

In some embodiments, the first lignin is isolated from lignocellulose (e.g., naturally-occurring lignocellulose) by any process including pulping processes (e.g., organosolv, lignosulfonate, soda, and kraft processes) and hydrolysis processes. The first lignin can be isolated with or without pre-treatment. In some embodiments, the first lignin can be a hydrolysis lignin or a pulping lignin.

In some embodiments, the first lignin is produced by separation of crude lignin from lignocellulose or by an additional process step on crude lignin to produce a lignin fraction or a lignin derivative, preferably wherein the separation process is a pulping process or a hydrolytic process, more preferably a kraft process producing kraft lignin, a soda process producing soda lignin, an organosolv process producing organosolv lignin or a sulphite process producing lignosulphonates.

In some embodiments, the first lignin is a kraft lignin, a kraft lignin fraction, a kraft lignin derivative, a soda lignin, a soda lignin fraction, a soda lignin derivative, an organosolv lignin, an organosolv lignin fraction, an organosolv lignin derivative, a lignosulphonate, a lignosulphonate fraction, and/or a lignosulphonate derivative.

In some embodiments, the first lignin is a kraft lignin, a soda lignin, an organosolv lignin, or a lignosulphonate.

In some embodiments, a hydroxyl group of said first lignin has not previously been chemically modified. In some preferred embodiments, a hydroxyl group of said first lignin has not been previously chemically modified by reaction with an alcohol, preferably a diol, preferably an aliphatic diol, an aromatic diol, or a diol of Formula (II); more preferably a diol of Formula II.

In some embodiments, the first lignin is produced by extraction of the soluble fraction of a hydrolytic lignin with an extraction solvent, preferably wherein the extraction solvent is also used for the pulping of lignin, preferably wherein the extraction solvent is aqueous sodium hydroxide or ethanol.

In some preferred embodiments, the first lignin (i) is at least 70% pure as measured by Klason lignin; or (ii) has an aliphatic —OH content of at least 0.5 mmol/g.

In some preferred embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid, glycerol, or a combination thereof.

In preferred embodiments, the first lignin has a high percentage of aliphatic hydroxyl groups. In preferred embodiments, the first lignin has from about 1.0 to about 5.0 mmol/g aliphatic OH. In some embodiments, the first lignin has from about 1.1 to about 5.0 mmol/g aliphatic OH. In some embodiments, the first lignin has from about 1.2 to about 5.0 mmol/g aliphatic OH. In some embodiments, the first lignin has from about 1.3 to about 5.0 mmol/g aliphatic OH. In some embodiments, the first lignin has from about 1.4 to about 5.0 mmol/g aliphatic OH. In some embodiments, the first lignin has from about 1.5 to about 5.0 mmol/g aliphatic OH. In some embodiments, the first lignin has from about 1.6 to about 5.0 mmol/g aliphatic OH. In some embodiments, the first lignin has from about 1.7 to about 5.0 mmol/g aliphatic OH. In some embodiments, the first lignin has from about 1.8 to about 5.0 mmol/g aliphatic OH. In some embodiments, the first lignin has from about 1.9 to about 5.0 mmol/g aliphatic OH. In some embodiments, the first lignin has from about 2.0 to about 5.0 mmol/g aliphatic OH. In some embodiments, the first lignin has from about 2.1 to about 5.0 mmol/g aliphatic OH. In some embodiments, the first lignin has from about 2.2 to about 5.0 mmol/g aliphatic OH. In some embodiments, the first lignin has from about 2.3 to about 5.0 mmol/g aliphatic OH. In some embodiments, the first lignin has from about 2.4 to about 5.0 mmol/g aliphatic OH. In some embodiments, the first lignin has from about 2.5 to about 5.0 mmol/g aliphatic OH. In some embodiments, the first lignin has from about 2.6 to about 5.0 mmol/g aliphatic OH. In some embodiments, the first lignin has from about 2.7 to about 5.0 mmol/g aliphatic OH. In some embodiments, the first lignin has from about 2.8 to about 5.0 mmol/g aliphatic OH. In some embodiments, the first lignin has from about 2.9 to about 5.0 mmol/g aliphatic OH. In some embodiments, the first lignin has from about 3.0 to about 5.0 mmol/g aliphatic OH. In some embodiments, the first lignin has from about 3.25 to about 5.0 mmol/g aliphatic OH. In some embodiments, the first lignin has from about 3.5 to about 5.0 mmol/g aliphatic OH. In some embodiments, the first lignin has from about 3.75 to about 5.0 mmol/g aliphatic OH. In some embodiments, the first lignin has from about 4.0 to about 5.0 mmol/g aliphatic OH. In some embodiments, the first lignin has from about 4.25 to about 5.0 mmol/g aliphatic OH. In some embodiments, the first lignin has from about 4.5 to about 5.0 mmol/g aliphatic OH. In some embodiments, the first lignin has from about 4.75 to about 5.0 mmol/g aliphatic OH.

In preferred embodiments, the first lignin has a high percentage of phenolic hydroxyl groups. In preferred embodiments, the first lignin has from about 0.9 to about 5.0 mmol/g phenolic OH. In preferred embodiments, the first lignin has from about 1.0 to about 5.0 mmol/g phenolic OH. In some embodiments, the first lignin has from about 1.1 to about 5.0 mmol/g phenolic OH. In some embodiments, the first lignin has from about 1.2 to about 5.0 mmol/g phenolic OH. In some embodiments, the first lignin has from about 1.3 to about 5.0 mmol/g phenolic OH. In some embodiments, the first lignin has from about 1.4 to about 5.0 mmol/g phenolic OH. In some embodiments, the first lignin has from about 1.5 to about 5.0 mmol/g phenolic OH. In some embodiments, the first lignin has from about 1.6 to about 5.0 mmol/g phenolic OH. In some embodiments, the first lignin has from about 1.7 to about 5.0 mmol/g phenolic OH. In some embodiments, the first lignin has from about 1.8 to about 5.0 mmol/g phenolic OH. In some embodiments, the first lignin has from about 1.9 to about 5.0 mmol/g phenolic OH. In some embodiments, the first lignin has from about 2.0 to about 5.0 mmol/g phenolic OH. In some embodiments, the first lignin has from about 2.1 to about 5.0 mmol/g phenolic OH. In some embodiments, the first lignin has from about 2.2 to about 5.0 mmol/g phenolic OH. In some embodiments, the first lignin has from about 2.3 to about 5.0 mmol/g phenolic OH. In some embodiments, the first lignin has from about 2.4 to about 5.0 mmol/g phenolic OH. In some embodiments, the first lignin has from about 2.5 to about 5.0 mmol/g phenolic OH. In some embodiments, the first lignin has from about 2.6 to about 5.0 mmol/g phenolic OH. In some embodiments, the first lignin has from about 2.7 to about 5.0 mmol/g phenolic OH. In some embodiments, the first lignin has from about 2.8 to about 5.0 mmol/g phenolic OH. In some embodiments, the first lignin has from about 2.9 to about 5.0 mmol/g phenolic OH. In some embodiments, the first lignin has from about 3.0 to about 5.0 mmol/g phenolic OH. In some embodiments, the first lignin has from about 3.25 to about 5.0 mmol/g phenolic OH. In some embodiments, the first lignin has from about 3.5 to about 5.0 mmol/g phenolic OH. In some embodiments, the first lignin has from about 3.75 to about 5.0 mmol/g phenolic OH. In some embodiments, the first lignin has from about 4.0 to about 5.0 mmol/g phenolic OH. In some embodiments, the first lignin has from about 4.25 to about 5.0 mmol/g phenolic OH. In some embodiments, the first lignin has from about 4.5 to about 5.0 mmol/g phenolic OH. In some embodiments, the first lignin has from about 4.75 to about 5.0 mmol/g phenolic OH.

### Modified (Second) Lignins

Without wishing to be bound by theory, the inventive process efficiently etherifies one or more hydroxy groups, preferably one or more aliphatic hydroxy groups, more preferably one or more alpha-hydroxy groups of the phenylpropane units of the first lignin to produce a chemically modified, i.e., etherified second lignin. In preferred embodiments, by extending the length of the aliphatic portion of the phenylpropane units, the inventive process modifies (e.g., improves) the melting characteristics of the first lignin (e.g., lowers the melting temperature of the first lignin; converts a partially melting first lignin to a completely meltable second lignin; and/or reduces the melting viscosity of the first lignin). In some embodiments, the inventive process also etherifies one or more phenolic hydroxyl groups of the first lignin to produce a chemically modified, i.e., etherified second lignin.

In preferred embodiments, by chemically modifying (preferably etherifying) the first lignin to produce a chemically modified second lignin, the second lignin has modified melting characteristics compared to the first lignin. In preferred embodiments, modifying the melting characteristics of the first lignin can comprise (i) lowering the melting temperature of the first lignin; (ii) converting a partially meltable first lignin (e.g., at a given temperature) to a completely meltable second lignin (e.g., at the same temperature); and/or (iii) reducing the melting viscosity of the first lignin.

In some embodiments, the inventive process lowers the melting temperature of the first lignin. In some embodiments, the inventive process lowers the melting temperature of the first lignin and converts the first lignin from a partially meltable lignin (e.g., at a given temperature) to a completely meltable second lignin (e.g., at the same temperature). In some embodiments, the inventive process lowers the melting temperature of the first lignin and reduces the melting viscosity of the first lignin. In some embodiments, the inventive process lowers the melting temperature of the first lignin; converts the first lignin from a partially meltable lignin (e.g., at a given temperature) to a completely meltable second lignin (e.g., at the same temperature); and reduces the melting viscosity of the first lignin. In some embodiments, the inventive process converts the first lignin from a partially meltable lignin (e.g., at a given temperature) to a completely meltable second lignin (e.g., at the same temperature). In some embodiments, the inventive process reduces the melting viscosity of the first lignin. In some embodiments, the inventive process converts the first lignin from a partially meltable lignin (e.g., at a given temperature) to a completely meltable second lignin (e.g., at the same temperature) and reduces the melting viscosity of the first lignin.

In some embodiments, the inventive process raises the score, as measured by the Hot Plate Method, preferably the second embodiment (1-5 scale) of a first lignin such that the modified second lignin has a higher score as measured by the Hot Plate Method at a given temperature. For example, in some preferred embodiments, at a particular temperature (e.g., 140° C., 160° C., 180° C., and/or 210° C.), the inventive process can convert a first lignin having a low score as measured by the Hot Plate Method to a second lignin having a higher score as measured by the Hot Plate Method. In some preferred embodiments, the inventive process converts a first lignin having a score of 1 at a particular temperature (e.g., 140° C., 160° C., 180° C., or 210° C.) to a second lignin having a score of 2, 3, 4 or 5 at the same temperature as measured by the Hot Plate Method (preferably second embodiment). In some preferred embodiments, the inventive process converts a first lignin having a score of 2 at a particular temperature (e.g., 140° C., 160° C., 180° C., or 210° C.) to a second lignin having a score of 3, 4 or 5 at the same temperature as measured by the Hot Plate Method (preferably second embodiment). In some preferred embodiments, the inventive process converts a first lignin having a score of 3 at a particular temperature (e.g., 140° C., 160° C., 180° C., or 210° C.) to a second lignin having a score of 4 or 5 at the same temperature as measured by the Hot Plate Method (preferably second embodiment). In some preferred embodiments, the inventive process converts a first lignin having a score of 4 at a particular temperature (e.g., 140° C., 160° C., 180° C., or 210° C.) to a second lignin having a score of 5 at the same temperature as measured by the Hot Plate Method (preferably second embodiment).

In some embodiments, said chemical modification of said second lignin by said diol comprises etherification of said first lignin by said diol to produce an etherified second lignin.

In some preferred embodiments, the first lignin is etherified at an aliphatic hydroxyl group (preferably a primary hydroxy group) to produce an etherified second lignin. In some preferred embodiments, the second lignin is etherified by the alcohol at an aliphatic hydroxyl group. In some preferred embodiments, the second lignin is etherified by the alcohol at a primary aliphatic hydroxyl group.

In preferred embodiments, said inventive method chemoselectively modifies (preferably etherifies) one or more hydroxyl groups, preferably aliphatic hydroxyl groups of said first lignin over the phenolic hydroxyl groups of said first lignin.

In preferred embodiments, the ratio of chemically modified (preferably etherified) aliphatic hydroxyl groups to chemically modified (preferably etherified) phenolic hydroxyl groups is about 1:1. In preferred embodiments, the ratio of chemically modified (preferably etherified) aliphatic hydroxyl groups to chemically modified (preferably etherified) phenolic hydroxyl groups is about 0.9:1. In preferred embodiments, the ratio of chemically modified (preferably etherified) aliphatic hydroxyl groups to chemically modified (preferably etherified) phenolic hydroxyl groups is about 0.8:1. In preferred embodiments, the ratio of chemically modified (preferably etherified) aliphatic hydroxyl groups to chemically modified (preferably etherified) phenolic hydroxyl groups is about 0.7:1. In preferred embodiments, the ratio of chemically modified (preferably etherified) aliphatic hydroxyl groups to chemically modified (preferably etherified) phenolic hydroxyl groups is about 0.6:1. In preferred embodiments, the ratio of chemically modified (preferably etherified) aliphatic hydroxyl groups to chemically modified (preferably etherified) phenolic hydroxyl groups is about 0.5:1. In preferred embodiments, the ratio of chemically modified (preferably etherified) aliphatic hydroxyl groups to chemically modified (preferably etherified) phenolic hydroxyl groups is about 0.4:1. In preferred embodiments, the ratio of chemically modified (preferably etherified) aliphatic hydroxyl groups to chemically modified (preferably etherified) phenolic hydroxyl groups is about 1.1:1. In preferred embodiments, the ratio of chemically modified (preferably etherified) aliphatic hydroxyl groups to chemically modified (preferably etherified) phenolic hydroxyl groups is about 1.2:1. In preferred embodiments, the ratio of chemically modified (preferably etherified) aliphatic hydroxyl groups to chemically modified (preferably etherified) phenolic hydroxyl groups is about 1.3:1. In preferred embodiments, the ratio of chemically modified (preferably etherified) aliphatic hydroxyl groups to chemically modified (preferably etherified) phenolic hydroxyl groups is about 1.4:1. In preferred embodiments, the ratio of chemically modified (preferably etherified) aliphatic hydroxyl groups to chemically modified (preferably etherified) phenolic hydroxyl groups is about 1.5:1. In preferred embodiments, the ratio of chemically modified (preferably etherified) aliphatic hydroxyl groups to chemically modified (preferably etherified) phenolic hydroxyl groups is about 1.6:1. In preferred embodiments, the ratio of chemically modified (preferably etherified) aliphatic hydroxyl groups to chemically modified (preferably etherified) phenolic hydroxyl groups is about 1.7:1. In preferred embodiments, the ratio of chemically modified (preferably etherified) aliphatic hydroxyl groups to chemically modified (preferably etherified) phenolic hydroxyl groups is about 1.8:1. In preferred embodiments, the ratio of chemically modified (preferably etherified) aliphatic hydroxyl groups to chemically modified (preferably etherified) phenolic hydroxyl groups is about 1.9:1. In preferred embodiments, the ratio of chemically modified (preferably etherified) aliphatic hydroxyl groups to chemically modified (preferably etherified) phenolic hydroxyl groups is about 2:1. In preferred embodiments, the ratio of chemically modified (preferably etherified) aliphatic hydroxyl groups to chemically modified (preferably etherified) phenolic hydroxyl groups is about 2.5:1. In preferred embodiments, the ratio of chemically modified (preferably etherified) aliphatic hydroxyl groups to chemically modified (preferably etherified) phenolic hydroxyl groups is about 3:1. In preferred embodiments, the ratio of chemically modified (preferably etherified) aliphatic hydroxyl groups to chemically modified (preferably etherified) phenolic hydroxyl groups is about 4:1. In preferred embodiments, the ratio of chemically modified (preferably etherified) aliphatic hydroxyl groups to chemically modified (preferably etherified) phenolic hydroxyl groups is about 5:1. In preferred embodiments, the ratio of chemically modified (preferably etherified) aliphatic hydroxyl groups to chemically modified (preferably etherified) phenolic hydroxyl groups is about 6:1. In preferred embodiments, the ratio of chemically modified (preferably etherified) aliphatic hydroxyl groups to chemically modified (preferably etherified) phenolic hydroxyl groups is about 7:1. In preferred embodiments, the ratio of chemically modified (preferably etherified) aliphatic hydroxyl groups to chemically modified (preferably etherified) phenolic hydroxyl groups is about 8:1. In preferred embodiments, the ratio of chemically modified (preferably etherified) aliphatic hydroxyl groups to chemically modified (preferably etherified) phenolic hydroxyl groups is about 9:1. In preferred embodiments, the ratio of chemically modified (preferably etherified) aliphatic hydroxyl groups to chemically modified (preferably etherified) phenolic hydroxyl groups is about 10:1.

As used herein, the terms “second lignin” and “modified lignin” are interchangeable and both refer to a chemically modified version of the first lignin, preferably wherein the second lignin exhibits modified melting characteristics compared to the first lignin, more preferably wherein said modified melting characteristics include lowering the melting temperature of the first lignin; converting a partially meltable first lignin to a completely meltable second lignin; and/or reducing the melting viscosity of the first lignin.

In preferred embodiments, the second lignin is meltable at a temperature between 50° C. and 250° C., preferably between 100° C. and 220° C. In some preferred embodiments, the second lignin is meltable at a temperature between about 140° C. and about 210° C. In some preferred embodiments, the second lignin is meltable at a temperature of about 210° C. In some preferred embodiments, the second lignin is meltable at a temperature of about 200° C. In some preferred embodiments, the second lignin is meltable at a temperature of about 190° C. In some preferred embodiments, the second lignin is meltable at a temperature of about 180° C. In some preferred embodiments, the second lignin is meltable at a temperature of about 170° C. In some preferred embodiments, the second lignin is meltable at a temperature of about 160° C. In some preferred embodiments, the second lignin is meltable at a temperature of about 150° C. In some preferred embodiments, the second lignin is meltable at a temperature of about 140° C. In some preferred embodiments, the second lignin is meltable at a temperature of about 130° C. In some preferred embodiments, the second lignin is meltable at a temperature of about 120° C. In some preferred embodiments, the second lignin is meltable at a temperature of about 110° C. In some preferred embodiments, the second lignin is meltable at a temperature of about 100° C. In some preferred embodiments, the second lignin is meltable at a temperature of about 90° C. In some preferred embodiments, the second lignin is meltable at a temperature of about 80° C. or lower.

In preferred embodiments, the second lignin is a melting lignin or a partially melting lignin as defined according to the Hot Plate Method. In preferred embodiments, the second lignin obtains a score of 3 according to the Hot Plate Method (second embodiment, 0-5 scale), preferably at a temperature of 210° C. In preferred embodiments, the second lignin obtains a score of 4 or 5 according to the Hot Plate Method (second embodiment, 0-5 scale), preferably at a temperature of 210° C.

In one aspect, the present invention provides a modified lignin comprising a structural unit of the formula (I):

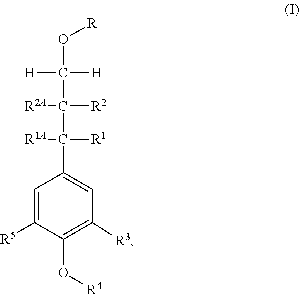

wherein:
R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
n is an integer from 1 to 10,000;
R^{A} and R^{B} are each independently H or C₁-C₆ alkyl;
R^{1A} is H and R¹ is independently selected from —H, —OH, —O-lignin polymer residue, lignin polymer residue, and a carbohydrate; or R^{1A} and R¹ combine together with the carbon atom to which they are attached to form a carbonyl group;
R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
R³ is independently selected from —H, —OCH₃, and lignin polymer residue;
R⁴ is independently selected from —H and lignin polymer residue; and
R⁵ is independently selected from —H, —OCH₃, and lignin polymer residue.

In some embodiments, at least one of R¹, R^{1A}, R², R^{2A}, R³, R⁴ and R⁵ is connected to one or more additional lignin structural units. In some embodiments, at least one of R¹, R^{1A}, R², R^{2A}, R³, R⁴ and R⁵ is connected to a polymeric lignin.

In some embodiments of the inventive process, the second lignin comprises a structural unit of the formula (I):

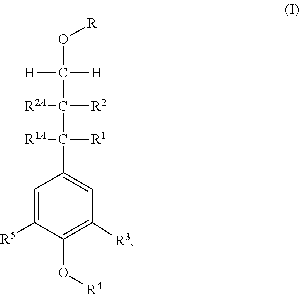

wherein:
R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
n is an integer from 1 to 10,000;
R^{A} and R^{B} are each independently H or C₁-C₆ alkyl;
R^{1A} is H and R¹ is independently selected from —H, —OH, —O-lignin-polymer residue, lignin polymer residue, and a carbohydrate; or R^{1A} and R¹ combine together with the carbon atom to which they are attached to form a carbonyl group;
R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
R³ is independently selected from —H, —OCH₃, and lignin polymer residue;
R⁴ is independently selected from —H and lignin polymer residue; and
R⁵ is independently selected from —H, —OCH₃, and lignin polymer residue.

In some embodiments, at least one of R¹, R^{1A}, R², R^{2A}, R³, R⁴ and R⁵ is connected to one or more additional lignin structural units. In some embodiments, at least one of R¹, R^{1A}, R², R^{2A}, R³, R⁴ and R⁵ is connected to a polymeric lignin.

In some embodiments, the invention provides a second lignin obtained by the inventive process as described herein, wherein the second lignin comprises a structural unit of the formula (I):

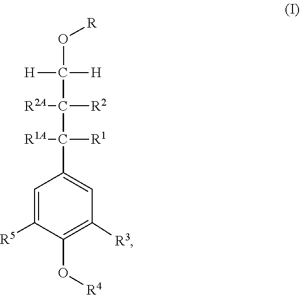

wherein:
R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
n is an integer from 1 to 10,000;
R^{A} and R^{B} are each independently H or C₁-C₆ alkyl;
R^{1A} is H and R¹ is independently selected from —H, —OH, —O-lignin polymer residue, lignin polymer residue, and a carbohydrate; or R^{1A} and R¹ combine together with the carbon atom to which they are attached to form a carbonyl group;
R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
R³ is independently selected from —H, —OCH₃, and lignin polymer residue;
R⁴ is independently selected from —H and lignin polymer residue; and
R⁵ is independently selected from —H, —OCH₃, and lignin polymer residue.

In some embodiments, the invention provides a chemically modified lignin obtained by a process comprising:
reacting a first lignin with a diol in a high-shear reactor to produce said modified lignin;
wherein said first lignin is a partially meltable lignin, a meltable lignin, or wherein the first lignin can be plasticized to become a partially meltable lignin or a meltable lignin;
wherein said diol is an aliphatic diol, an aromatic diol, or a diol of Formula (II):

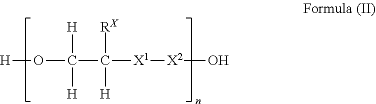

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH;
n is any integer from 1 to 10,000;
   wherein the modified lignin comprises a structural unit of the formula (I):

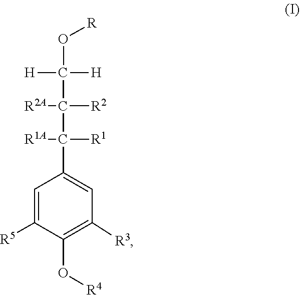

wherein:
   R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
   n is an integer from 1 to 10,000;
   R^{A} and R^{B} are each independently H or C₁-C₆ alkyl;
   R^{1A} is H and R¹ is independently selected from —H, —OH, —O-lignin polymer residue, lignin polymer residue, and a carbohydrate; or R^{1A} and R¹ combine together with the carbon atom to which they are attached to form a carbonyl group;
   R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
   R³ is independently selected from —H, —OCH₃, and lignin polymer residue;
   R⁴ is independently selected from —H and lignin polymer residue; and
   R⁵ is independently selected from —H, —OCH₃, and lignin polymer residue.

In some embodiments, at least one of R¹, R^{1A}, R², R^{2A}, R³, R⁴ and R⁵ is connected to one or more additional lignin structural units. In some embodiments, at least one of R¹, R^{1A}, R², R^{2A}, R³, R⁴ and R⁵ is connected to a polymeric lignin.

In preferred embodiments, R is selected from C₁-C₂₀ alkyl, —(CHR^{A}—CHR^{B}—O)ₙ—H, and C₆-C₁₄ aryl, wherein each alkyl or aryl is optionally substituted by exactly one —OH.

In preferred embodiments, R is selected from C₁-C₂₀ alkyl, —(CHR^{A}—CHR^{B}—O)ₙ—H, and C₆ aryl, wherein each alkyl is optionally substituted by exactly one —OH and each aryl is optionally substituted by exactly one —OH.

In preferred embodiments of formula (I), R is selected from C₁-C₂₀ alkyl, —(CHR^{A}—CHR^{B}—O)ₙ—H, and C₆ aryl, wherein each alkyl is optionally substituted by exactly one —OH and each aryl is optionally substituted by exactly one —OH; R^{A} is H and R^{B} is H or C₁-C₆ alkyl. In more preferred embodiments, R is selected from C₁-C₂₀ alkyl, —(CHR^{A}—CHR^{B}—O)ₙ—H, and C₆ aryl, wherein each alkyl is optionally substituted by exactly one —OH and each aryl is optionally substituted by exactly one —OH; R^{A} is H and R^{B} is H or C₁-C₂ alkyl. In yet more preferred embodiments, R is selected from C₁-C₂₀ alkyl, —(CHR^{A}—CHR^{B}—O)ₙ—H, and C₆ aryl, wherein each alkyl is optionally substituted by exactly one —OH and each aryl is optionally substituted by exactly one —OH; R^{A} is H and R^{B} is H or methyl, preferably H.

In some embodiments of formula (I), R is C₂-C₂₀ alkyl, preferably wherein said alkyl is substituted by exactly one —OH. In some embodiments, R is C₂-C₂₀ unbranched alkyl, preferably wherein said unbranched alkyl is substituted by exactly one —OH at the terminal carbon. In some embodiments, R is C₂-C₁₀ unbranched alkyl, preferably wherein said unbranched alkyl is substituted by exactly one —OH at the terminal carbon. In some embodiments, R is C₂-C₆ unbranched alkyl, preferably wherein said unbranched alkyl is substituted by exactly one —OH at the terminal carbon. In some embodiments, R is C₂ unbranched alkyl, preferably wherein said unbranched alkyl is substituted by exactly one —OH at the terminal carbon. In some embodiments, R is C₃ unbranched alkyl, preferably wherein said unbranched alkyl is substituted by exactly one —OH at the terminal carbon. In some embodiments, R is C₄ unbranched alkyl, preferably wherein said unbranched alkyl is substituted by exactly one —OH at the terminal carbon. In some embodiments, R is C₅ unbranched alkyl, preferably wherein said unbranched alkyl is substituted by exactly one —OH at the terminal carbon. In some embodiments, R is C₆ unbranched alkyl, preferably wherein said unbranched alkyl is substituted by exactly one —OH at the terminal carbon.

In some embodiments of formula (I), R is C₆ aryl, preferably wherein said aryl is substituted by exactly one —OH.

In preferred embodiments of formula (I), R is —(CHR^{A}—CHR^{B}—O)ₙ—H and n is 1; R^{A} is H; and R^{B} is H or methyl, preferably H. In preferred embodiments, R is —(CHR^{A}—CHR^{B}—O)ₙ—H and n is 2; R^{A} is H; and R^{B} is H or methyl, preferably H. In preferred embodiments, R is —(CHR^{A}—CHR^{B}—O)ₙ—H and n is 3; R^{A} is H; and R^{B} is H or methyl, preferably H. In preferred embodiments, R is —(CHR^{A}—CHR^{B}—O)ₙ—H and n is 4; R^{A} is H; and R^{B} is H or methyl, preferably H. In preferred embodiments, R is —(CHR^{A}—CHR^{B}—O)ₙ—H and n is 5; R^{A} is H; and R^{B} is H or methyl, preferably H. In preferred embodiments, R is —(CHR^{A}—CHR^{B}—O)ₙ—H and n is 6; R^{A} is H; and R^{B} is H or methyl, preferably H. In preferred embodiments, R is —(CHR^{A}—CHR^{B}—O)ₙ—H and n is 7; R^{A} is H; and R^{B} is H or methyl, preferably H. In preferred embodiments, R is —(CHR^{A}—CHR^{B}—O)ₙ—H and n is 8; R^{A} is H; and R^{B} is H or methyl, preferably H. In preferred embodiments, R is —(CHR^{A}—CHR^{B}—O)ₙ—H and n is 9; R^{A} is H; and R^{B} is H or methyl, preferably H. In preferred embodiments, R is —(CHR^{A}—CHR^{B}—O)ₙ—H and n is 10; R^{A} is H; and R^{B} is H or methyl, preferably H.

In preferred embodiments of formula (I), R is —(CHR^{A}—CHR^{B}—O)ₙ—H; R^{A} is H; and R^{B} is H or methyl, preferably H; and n is between about 7 and about 230. In preferred embodiments, R^{A} is H; and R^{B} is H or methyl, preferably H; and n is between about 7 and about 115. In preferred embodiments, R^{A} is H; and R^{B} is H or methyl, preferably H; and n is between about 7 and about 25. In preferred embodiments, R^{A} is H; and R^{B} is H or methyl, preferably H; and n is between about 7 and about 20. In preferred embodiments, R^{A} is H; and R^{B} is H or methyl, preferably H; and n is between about 7 and about 18. In preferred embodiments, R^{A} is H; and R^{B} is H or methyl, preferably H; and n is between about 7 and about 16. In preferred embodiments, R^{A} is H; and R^{B} is H or methyl, preferably H; and n is between about 7 and about 14. In preferred embodiments, R^{A} is H; and R^{B} is H or methyl, preferably H; and n is between about 7 and about 11. In preferred embodiments, R^{A} is H; and R^{B} is H or methyl, preferably H; and n is between about 7 and about 10. In preferred embodiments, R^{A} is H; and R^{B} is H or methyl, preferably H; and n is about 9. In preferred embodiments, R^{A} is H; and R^{B} is H or methyl, preferably H; and n is about 18 In preferred embodiments, R^{A} is H; and R^{B} is H or methyl, preferably H; and n is about 27.

### Reactors

The inventive process can be carried out using a variety of different reactors that can combine a first lignin with an alcohol under the appropriate conditions of temperature, pressure, torque, and residence time. In some embodiments, the reactor is a screw reactor or a screw extruder, preferably a twin-screw extruder.

In preferred embodiments, the reactor is a high-shear reactor. As used herein, the term “high-shear reactor” is understood as a reactor that disperses, or transports, one phase or ingredient (liquid, solid, gas) into a main continuous phase (e.g., a liquid). A rotor or impeller or a screw, together with a stationary component known as a stator, or an array of rotors and stators, is used either in a tank containing the solution to be mixed, or in a pipe through which the solution passes, to create shear.

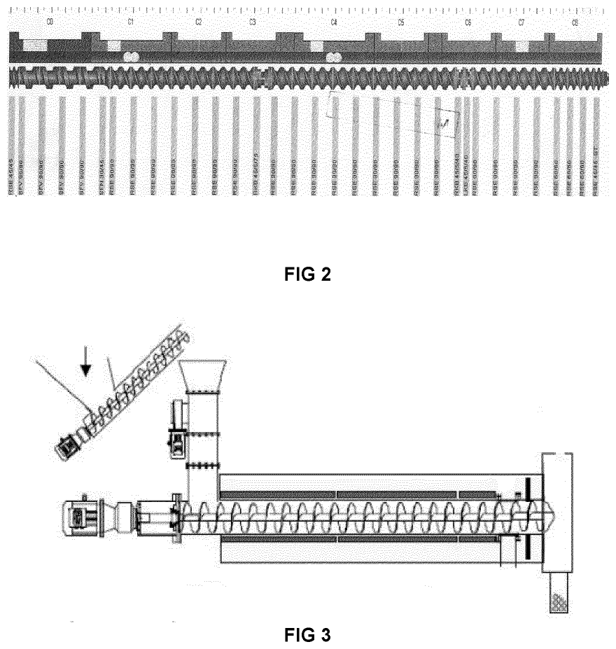

In preferred embodiments, the reactor is a high-shear reactor wherein said high-shear reactor is an extruder, preferably a screw extruder, more preferably a single screw extruder or a twin-screw extruder (also known as a double screw extruder), yet more preferably said high-shear reactor is a twin-screw extruder with corotating screws or counterrotating screws, preferably corotating screws. As used herein, an “extruder” is a machine that can extrude a viscous material (preferably a mixture of a first lignin and an alcohol such as a diol) through a die. A “screw extruder” is a type of extruder in which the viscous material (e.g., the mixture of a first lignin and an alcohol such as a diol) are moved through a cylinder using one or more turning screws. A “single screw extruder” is a screw extruder comprising one screw. A “twin-screw extruder” comprises two screws, coupled and co-rotating, located inside a closed barrel. FIG. 2 is an annotated schematic of a screw used in the twin-screw extruder used in Examples 2 and 3.

In some preferred embodiments, the reactor is a high-shear reactor wherein said high-shear reactor is screw reactor. As used herein, a screw extruder is a type of screw reactor. FIG. 3 shows a schematic of an exemplary screw reactor that can be used to carry out the inventive process. In some embodiments, the high-shear reactor is a screw reactor or a screw extruder, preferably wherein said high-shear reactor is a twin-screw extruder.

In some embodiments, said reactor is a high-shear reactor wherein said shear stress within said high-shear reactor is from about 100 N/m² to about 2,000,000 N/m². In some embodiments, said reactor is a high-shear reactor wherein said shear stress within said high-shear reactor is from about 100 N/m² to about 1,750,000 N/m². In some embodiments, said reactor is a high-shear reactor wherein said shear stress within said high-shear reactor is from about 100 N/m² to about 1,500,000 N/m². In some embodiments, said reactor is a high-shear reactor wherein said shear stress within said high-shear reactor is from about 100 N/m² to about 1,250,000 N/m². In some embodiments, said reactor is a high-shear reactor wherein said shear stress within said high-shear reactor is from about 100 N/m² to about 1,000,000 N/m². In some embodiments, said reactor is a high-shear reactor wherein said shear stress within said high-shear reactor is from about 100 N/m² to about 750,000 N/m². In some embodiments, said reactor is a high-shear reactor wherein said shear stress within said high-shear reactor is from about 100 N/m² to about 500,000 N/m². In some embodiments, said reactor is a high-shear reactor wherein said shear stress within said high-shear reactor is from about 100 N/m² to about 250,000 N/m². In some embodiments, said reactor is a high-shear reactor wherein said shear stress within said high-shear reactor is from about 100 N/m² to about 100,000 N/m². In some embodiments, said reactor is a high-shear reactor wherein said shear stress within said high-shear reactor is from about 100 N/m² to about 75,000 N/m². In some embodiments, said reactor is a high-shear reactor wherein said shear stress within said high-shear reactor is from about 100 N/m² to about 50,000 N/m². In some embodiments, said reactor is a high-shear reactor wherein said shear stress within said high-shear reactor is from about 100 N/m² to about 25,000 N/m². In some embodiments, said reactor is a high-shear reactor wherein said shear stress within said high-shear reactor is from about 10,000 N/m², preferably 100,000 N/m², preferably 110,000 N/m² to about 2,000,000 N/m². In some embodiments, said reactor is a high-shear reactor wherein said shear stress within said high-shear reactor is from about 10,000 N/m², preferably 100,000 N/m², preferably 110,000 N/m² N/m² to about 1,750,000 N/m². In some embodiments, said reactor is a high-shear reactor wherein said shear stress within said high-shear reactor is from about 10,000 N/m², preferably 100,000 N/m², preferably 110,000 N/m² N/m² to about 1,500,000 N/m². In some embodiments, said reactor is a high-shear reactor wherein said shear stress within said high-shear reactor is from about 10,000 N/m², preferably 100,000 N/m², preferably 110,000 N/m² N/m² to about 1,250,000 N/m². In some embodiments, said reactor is a high-shear reactor wherein said shear stress within said high-shear reactor is from about 10,000 N/m², preferably 100,000 N/m², preferably 110,000 N/m² N/m² to about 1,000,000 N/m². In some embodiments, said reactor is a high-shear reactor wherein said shear stress within said high-shear reactor is from about 10,000 N/m², preferably 100,000 N/m², preferably 110,000 N/m² N/m² to about 750,000 N/m². In some embodiments, said reactor is a high-shear reactor wherein said shear stress within said high-shear reactor is from about 10,000 N/m², preferably 100,000 N/m², preferably 110,000 N/m² N/m² to about 500,000 N/m². In some embodiments, said reactor is a high-shear reactor wherein said shear stress within said high-shear reactor is from about 10,000 N/m², preferably 100,000 N/m², preferably 110,000 N/m² N/m² to about 250,000 N/m². In some embodiments, said reactor is a high-shear reactor wherein said shear stress within said high-shear reactor is from about 10,000 N/m² to about 100,000 N/m².

In some embodiments, said reactor is a high-shear reactor wherein said shear stress within said high-shear reactor is from about 100 N/m² to about 10,000 N/m². In some embodiments, said shear stress within said high-shear reactor is from about 100 N/m² to about 8,000 N/m². In some embodiments, said shear stress within said high-shear reactor is from about 200 N/m² to about 6,000 N/m². In some embodiments, said shear stress within said high-shear reactor is from about 300 N/m² to about 4,000 N/m². In some embodiments, said shear stress within said high-shear reactor is from about 400 N/m² to about 2,000 N/m². In some embodiments, said shear stress within said high-shear reactor is from about 500 N/m² to about 1,000 N/m².

In some preferred embodiments, a reactor (e.g., a high-shear reactor, preferably a screw extruder or screw reactor) can comprise one or more zones. As used herein, a “zone” of a reactor (e.g., a high-shear reactor, preferably a screw extruder or screw reactor) is understood as a section within the reactor (preferably a high-shear reactor) that is defined by particular values for temperature, preferably temperature and more preferably wherein each zone has an independent heating and cooling system for maintaining said zone at a given temperature. The exemplary twin-screw extruder shown in FIG. 2 has nine zones, although a reactor can have any number of zones, e.g., one, two, three, four, five, six, seven, eight, nine, ten, eleven, twelve, thirteen, fourteen, fifteen, sixteen, seventeen, eighteen, nineteen, twenty, or more than twenty zones.

In some embodiments, the reactor (e.g., a high-shear reactor such as an extruder) has between 1 and 15 zones, the lignin is added at a first zone, and the alcohol (preferably a diol) is added at one or more later zones, preferably in a second zone, more preferably in a third, fourth, fifth or later zone.

In some embodiments, the reactor (preferably a high-shear reactor) is a screw reactor or screw extruder, and the zones of the screw reactor or screw extruder have different lengths along the axis of the screw. If one or more zones have different values for, e.g., temperature, and/or pressure and also have different lengths, then it is necessary to account for the difference in length when calculating the average of temperature and/or pressure across all of the zones of the reactor (preferably a high-shear reactor).

In some embodiments, different zones can serve different purposes within the reactor (preferably a high-shear reactor). In some embodiments certain zones (preferably early zones) of a reactor are used to homogenize the mixture of a first lignin and an alcohol (preferably a diol). In some embodiments, other zones (e.g., later zones) of the reactor (e.g., a high-shear reactor) can be used to react the first lignin with the alcohol (preferably a diol). Such zones in which a chemical reaction between the first lignin and the alcohol (preferably a diol) take place are termed “reactive zones.”

The first lignin and/or alcohol (preferably a diol) can be injected into any of the zones of the reactor (e.g., a high-shear reactor such as a screw extruder or screw reactor). In preferred embodiments the reactor (e.g., a high-shear reactor such as a screw reactor or screw extruder) is configured to combine a first lignin and an alcohol (preferably a diol) for a residence time that is sufficient to allow the lignin to react with the alcohol (preferably a diol) to form a modified lignin. As used herein, the term “residence time” refers to the amount time a lignin is mixed with an alcohol (preferably a diol) inside the reactor, preferably within a reactive zone.

In some embodiments, the first lignin and the alcohol (preferably a diol) are combined to form a homogenous mixture outside the reactor (preferably a high-shear reactor), and said homogenous mixture is subsequently added to the reactor (e.g., a high-shear reactor such as a screw reactor or screw extruder) to carry out the inventive process.

In some embodiments, the first lignin is added to the reactor (preferably a high-shear reactor), and the alcohol (preferably a diol) is added to the reactor after the first lignin (e.g., at a different zone of the reactor than the first lignin). In some preferred embodiments, the first lignin and the alcohol (preferably a diol) are homogenized inside the reactor (e.g., within one or more non-reactive zones of the reactor, preferably within one or more non-reactive zones of the high-shear reactor).

In some embodiments, the alcohol (preferably a diol) is added to the reactor (preferably a high-shear reactor), and the first lignin is added later to the reactor after the alcohol (e.g., at a different zone of the reactor than the alcohol). In some embodiments, the alcohol and the first lignin are homogenised inside the reactor (e.g., within one or more non-reactive zones of the reactor).

In embodiments wherein the first lignin and the alcohol (preferably a diol) are homogenized inside the reactor (preferably a high-shear reactor), the residence time is the amount of time that both the first lignin and the alcohol are in contact in the reactor, preferably within a reactive zone of the reactor.

In preferred embodiments, the reactor (preferably a high-shear reactor) or a zone (e.g., a reactive zone) of the reactor creates an amount of torque and/or pressure to chemically modify the first lignin, preferably to etherify the first lignin, at a lower temperature than if the same reaction were carried out at atmospheric pressure. In preferred embodiments, the reaction takes place at a temperature below about 120° C.

### Operating Parameters

The inventive process can be carried out using a variety of different reactors that can combine a first lignin with an alcohol under the appropriate conditions of temperature, pressure, torque, and residence time.

Without wishing to be bound by theory, shear stress is not the same as pressure, although they share the same unit of measurement, which is typically expressed in pascals (Pa) or newtons per square meter (N/m²). As used herein, pressure is a scalar quantity that represents the force per unit area exerted on a surface. It acts perpendicular to the surface and is equal in all directions (isotropic) in a fluid. It is often associated with fluids and gases, where the force is distributed equally in all directions. As used herein “shear stress” is a type of stress that arises when two adjacent layers of a material slide past each other in opposite directions. It represents the force per unit area parallel to the surface. Shear stress occurs in solids, such as beams or plates, where forces are applied parallel to the surface, causing deformation and shear. While both pressure and shear stress involve forces applied to an area, a key distinction lies in the direction of the forces and the resulting deformation. Pressure acts perpendicular to the surface and causes uniform compression, while shear stress acts parallel to the surface and leads to the shearing or sliding of material layers.

In some embodiments the first lignin and the alcohol (e.g., a diol) are reacted in the reactor (preferably a high shear reactor) for between about 2 seconds and about 20 minutes, preferably between about 3 seconds and about 5 minutes, more preferably between about 5 seconds and about 2 minutes, yet more preferably between about 10 seconds and about 60 seconds.

In some embodiments, the first lignin and the alcohol (e.g., a diol) are reacted in one or more reactive zones of the reactor (preferably a high shear reactor) for between about 2 seconds and about 20 minutes, preferably between about 3 seconds and about 5 minutes, more preferably between about 5 seconds and about 2 minutes, yet more preferably between about 10 seconds and about 60 seconds. In some preferred embodiments, the first lignin and the alcohol are reacted in one or more reactive zones of the reactor for between about one second and about 60 seconds, preferably between about five seconds and about 30 seconds, more preferably between about five seconds and about 15 seconds.

In some embodiments, the first lignin and the alcohol (e.g., a diol) are reacted in one or more reactive zones of the reactor (preferably a high shear reactor) for about 2 seconds to about 20 minutes; for about 5 seconds to about 15 minutes; for about 10 seconds to about 10 minutes; for about 30 seconds to about 10 minutes; or for about 30 seconds to about 5 minutes.

In some embodiments, the first lignin and the alcohol (e.g., a diol) are reacted in one or more reactive zones of said high shear reactor for about 2 seconds to about 20 minutes, preferably from about 30 seconds to about 5 minutes. In preferred embodiments, said first lignin and the alcohol (e.g., a diol) are reacted in one or more reactive zones of said high shear reactor for about 30 seconds to about 5 minutes.

In some embodiments, the first lignin and the diol are reacted in the high-shear reactor at a temperature from about 50° C. to about 200° C.; preferably from about 70° C. to about 120° C. In some embodiments, the first lignin and the alcohol (preferably a diol) are reacted in the reactor (preferably a high-shear reactor) at a temperature between about 50° C. and about 150° C.; preferably between about 70° C. and about 120° C. In some embodiments, the first lignin and the alcohol (preferably a diol are reacted in the reactor (preferably a high-shear reactor) at a temperature from about 50° C. to about 150° C.; from about 60° C. to about 140° C.; from about 70° C. to about 130° C.; from about 70° C. to about 120° C.; from about 70° C. to about 110° C.; or from about 70° C. to about 100° C.

In some embodiments, the first lignin and the alcohol are reacted in one or more reactive zones of the reactor at temperature between about 50° C. and about 150° C.; preferably between about 70° C. and about 120° C. In some embodiments, the first lignin and the alcohol (preferably a diol are reacted in one or more reactive zones of the reactor (preferably a high-shear reactor) at a temperature from about 50° C. to about 150° C.; from about 60° C. to about 140° C.; from about 70° C. to about 130° C.; from about 70° C. to about 120° C.; from about 70° C. to about 110° C.; or from about 70° C. to about 100° C.

In some embodiments, the first lignin and the alcohol (preferably a diol) are reacted in the reactor (preferably in one or more reactive zones of the reactor, preferably a high-shear reactor) at a temperature below about 150° C., more preferably below about 140° C., more preferably below about 130° C., more preferably below about 120° C., more preferably below about 110° C., more preferably below about 100° C., yet more preferably below about 90° C., yet more preferably below about 80° C., yet more preferably below about 70° C., yet more preferably below about 60° C., yet more preferably below about 50° C.

In some embodiments, the first lignin and the alcohol (preferably a diol) are reacted in the reactor (preferably in one or more reactive zones of the reactor, preferably a high-shear reactor) at a temperature of about 150° C.; about 140° C.; about 130° C.; about 120° C.; about 110° C.; about 100° C.; about 90° C.; about 80° C.; about 70° C.; about 60° C.; or about 50° C.

In some embodiments, the first lignin and the alcohol are reacted in the reactor at a pressure between about 1 bar and about 10 bar, preferably between about 3 bar and about 6 bar. In some embodiments, the first lignin and the alcohol are reacted in one or more reactive zones of the reactor at a pressure between about 1 bar and about 10 bar, preferably between about 3 bar and about 6 bar.

In some embodiments, the first lignin and the alcohol (preferably a diol) are reacted in the reactor (preferably a high-shear reactor) at a pressure from about 1.1 bar (0.11 MPa) to about 20 bar (2.0 MPa). In some embodiments, the first lignin and the alcohol (preferably a diol) are reacted in the reactor (preferably a high-shear reactor) at a pressure from about 1.1 bar (0.11 MPa) to about 19 bar (1.9 MPa). In some embodiments, the first lignin and the alcohol (preferably a diol) are reacted in the reactor (preferably a high-shear reactor) at a pressure from about 1.1 bar (0.11 MPa) to about 18 bar (1.8 MPa). In some embodiments, the first lignin and the alcohol (preferably a diol) are reacted in the reactor (preferably a high-shear reactor) at a pressure from about 1.1 bar (0.11 MPa) to about 17 bar (1.7 MPa). In some embodiments, the first lignin and the alcohol (preferably a diol) are reacted in the reactor (preferably a high-shear reactor) at a pressure from about 1.1 bar (0.11 MPa) to about 16 bar (1.6 MPa). In some embodiments, the first lignin and the alcohol (preferably a diol) are reacted in the reactor (preferably a high-shear reactor) at a pressure from about 1.1 bar (0.11 MPa) to about 15 bar (1.5 MPa). In some embodiments, the first lignin and the alcohol (preferably a diol) are reacted in the reactor (preferably a high-shear reactor) at a pressure from about 1.1 bar (0.11 MPa) to about 14 bar (1.4 MPa). In some embodiments, the first lignin and the alcohol (preferably a diol) are reacted in the reactor (preferably a high-shear reactor) at a pressure from about 1.1 bar (0.11 MPa) to about 13 bar (1.3 MPa). In some embodiments, the first lignin and the alcohol (preferably a diol) are reacted in the reactor (preferably a high-shear reactor) at a pressure from about 1.1 bar (0.11 MPa) to about 12 bar (1.2 MPa). In some embodiments, the first lignin and the alcohol (preferably a diol) are reacted in the reactor (preferably a high-shear reactor) at a pressure from about 2 bar (0.2 MPa) to about 12 bar (1.2 MPa). In some embodiments, the first lignin and the alcohol (preferably a diol) are reacted in the reactor (preferably a high-shear reactor) at a pressure between from about 2 bar (0.2 MPa) to about 11 bar (1.1 MPa). In some embodiments, the first lignin and the alcohol (preferably a diol) are reacted in the reactor (preferably a high-shear reactor) at a pressure from about 3 bar (0.3 MPa) to about 10 bar (1.0 MPa). In some preferred embodiments, the first lignin and the alcohol (preferably a diol) are reacted in the reactor (preferably a high-shear reactor) at a pressure from about 4 bar (0.4 MPa) to about 9 bar (0.9 MPa).

In some embodiments, the first lignin and the alcohol (preferably a diol) are reacted in the reactor (preferably a high-shear reactor) at a pressure between from about 4 bar (0.4 MPa) to about 5 bar (0.5 MPa). In some embodiments, the first lignin and the alcohol (preferably a diol) are reacted in the reactor (preferably a high-shear reactor) at a pressure from about 5 bar (0.5 MPa) to about 6 bar (0.6 MPa). In some embodiments, the first lignin and the alcohol (preferably a diol) are reacted in the reactor (preferably a high-shear reactor) at a pressure from about 6 bar (0.6 MPa) to about 7 bar (0.7 MPa). In some embodiments, the first lignin and the alcohol (preferably a diol) are reacted in the reactor (preferably a high-shear reactor) at a pressure about 7 bar (0.7 MPa) and about 8 bar (0.8 MPa). In some embodiments, the first lignin and the alcohol (preferably a diol) are reacted in the reactor (preferably a high-shear reactor) at a pressure about 8 bar (0.8 MPa) and about 9 bar (0.9 MPa).

In some embodiments, the first lignin and the alcohol (preferably a diol) are reacted in one or more reactive zones of the reactor (preferably a high-shear reactor) at a pressure from about 4 bar (0.4 MPa) to about 5 bar (0.5 MPa). In some embodiments, the first lignin and the alcohol (preferably a diol) are reacted in one or more reactive zones of the reactor (preferably a high-shear reactor) at a pressure from about 5 bar (0.5 MPa) to about 6 bar (0.6 MPa). In some embodiments, the first lignin and the alcohol (preferably a diol) are reacted in one or more reactive zones of the reactor (preferably a high-shear reactor) at a pressure from about 6 bar (0.6 MPa) to about 7 bar (0.7 MPa). In some embodiments, the first lignin and the alcohol (preferably a diol) are reacted in one or more reactive zones of the reactor (preferably a high-shear reactor) at a pressure from about 7 bar (0.7 MPa) and about 8 bar (0.8 MPa). In some embodiments, the first lignin and the alcohol (preferably a diol) are reacted in one or more reactive zones of the reactor (preferably a high-shear reactor) at a pressure from about 8 bar (0.8 MPa) and about 9 bar (0.9 MPa).

In some embodiments, the first lignin and the alcohol (preferably a diol) are reacted (preferably in one or more reactive zones of the reactor, preferably a high-shear reactor) at a pressure between about 1 bar (0.1 MPa) and about 5 bar (0.5 MPa), preferably between about 3 bar (0.3 MPa) and about 4 bar (0.4 MPa). In some embodiments, the first lignin and the alcohol are reacted (preferably in one or more reactive zones of the reactor, preferably a high-shear reactor) at a pressure of about 1 bar (0.1 MPa). In some embodiments, the first lignin and the alcohol are reacted (preferably in one or more reactive zones of the reactor, preferably a high-shear reactor) at a pressure of about 1.5 bar (0.15 MPa). In some embodiments, the first lignin and the alcohol are reacted (preferably in one or more reactive zones of the reactor, preferably a high-shear reactor) at a pressure of about 2 bar (0.2 MPa). In some embodiments, the first lignin and the alcohol are reacted (preferably in one or more reactive zones of the reactor, preferably a high-shear reactor) at a pressure of about 2.5 bar (0.25 MPa). In some embodiments, the first lignin and the alcohol are reacted (preferably in one or more reactive zones of the reactor, preferably a high-shear reactor) at a pressure of about 3 bar (0.3 MPa). In some embodiments, the first lignin and the alcohol are reacted (preferably in one or more reactive zones of the reactor, preferably a high-shear reactor) at a pressure of about 3.5 bar (0.35 MPa). In some embodiments, the first lignin and the alcohol are reacted (preferably in one or more reactive zones of the reactor, preferably a high-shear reactor) at a pressure of about 4 bar (0.4 MPa). In some embodiments, the first lignin and the alcohol are reacted (preferably in one or more reactive zones of the reactor, preferably a high-shear reactor) at a pressure of about 4.5 bar (0.45 MPa). In some embodiments, the first lignin and the alcohol are reacted (preferably in one or more reactive zones of the reactor, preferably a high-shear reactor) at a pressure of about 5 bar (0.5 MPa).

In some embodiments, the alcohol (preferably a diol) comprises between about 2% to about 60% of the total weight of the alcohol and first lignin. In some embodiments, the alcohol comprises between about 2% to about 55% of the total weight of the alcohol and first lignin. In some embodiments, the alcohol comprises between about 2% to about 50% of the total weight of the alcohol and first lignin. In some embodiments, the alcohol comprises between about 2% to about 45% of the total weight of the alcohol and first lignin. In some embodiments, the alcohol comprises between about 2% to about 40% of the total weight of the alcohol and first lignin. In some embodiments, the alcohol comprises between about 2% to about 35% of the total weight of the alcohol and first lignin. In some embodiments, the alcohol comprises between about 2% to about 30% of the total weight of the alcohol and first lignin. In some embodiments, the alcohol comprises between about 2% to about 25% of the total weight of the alcohol and first lignin. In some embodiments, the alcohol comprises between about 2% to about 20% of the total weight of the alcohol and first lignin. In some embodiments, the alcohol comprises between about 5% to about 15% of the total weight of the alcohol (preferably a diol) and first lignin.

Preferably, the alcohol (preferably a diol) comprises about 5% to about 15% of the total weight of the alcohol and the first lignin, more preferably about 5% to about 10% of the total weight of the alcohol and the first lignin. In some embodiments, the alcohol comprises about 5% of the total weight of the alcohol and the first lignin. In some embodiments, the alcohol comprises about 6% of the total weight of the alcohol and the first lignin. In some embodiments, the alcohol comprises about 7% of the total weight of the alcohol and the first lignin. In some embodiments, the alcohol comprises about 8% of the total weight of the alcohol and the first lignin. In some embodiments, the alcohol comprises about 9% of the total weight of the alcohol and the first lignin. In some embodiments, the alcohol comprises about 10% of the total weight of the alcohol and the first lignin. In some embodiments, the alcohol comprises about 110% of the total weight of the alcohol and the first lignin. In some embodiments, the alcohol comprises about 12% of the total weight of the alcohol and the first lignin. In some embodiments, the alcohol comprises about 13% of the total weight of the alcohol and the first lignin. In some embodiments, the alcohol comprises about 14% of the total weight of the alcohol and the first lignin. In some embodiments, the alcohol comprises about 15% of the total weight of the alcohol and the first lignin.

In some embodiments, the reactor is an extruder, preferably wherein a shaft of the extruder is between about 500 mm and about 20000 mm, preferably between about 2000 mm and about 5000 mm.

In some embodiments, the reactor is an extruder, preferably wherein a shaft of the extruder has a diameter between about 15 mm and about 150 mm, more preferably between about 35 mm and about 90 mm.

In some embodiments, the reactor is an extruder, preferably wherein the extruder operates with a torque (e.g., torque of the motor) of between about 50 Nm to about 17000 Nm, more preferably between about 90 Nm and about 4000 Nm.

In some embodiments, the reactor is a high-shear reactor, preferably an extruder, and wherein a torque of a motor of said high-shear reactor is from about 25 Nm to about 250 Nm. In some embodiments, the reactor is a high-shear reactor, preferably an extruder, and wherein a torque of a motor of said high-shear reactor is from about 50 Nm to about 225 Nm. In some embodiments, the reactor is a high-shear reactor, preferably an extruder, and wherein a torque of a motor of said high-shear reactor is from about 50 Nm to about 200 Nm. In some embodiments, the reactor is a high-shear reactor, preferably an extruder, and wherein a torque of a motor of said high-shear reactor is from about 70 Nm to about 200 Nm. In some embodiments, the reactor is a high-shear reactor, preferably an extruder, and wherein a torque of a motor of said high-shear reactor is from about 100 Nm to about 200 Nm. In some embodiments, the reactor is a high-shear reactor, preferably an extruder, and wherein a torque of a motor of said high-shear reactor is from about 125 Nm to about 200 Nm. In some embodiments, the reactor is a high-shear reactor, preferably an extruder, and wherein a torque of a motor of said high-shear reactor is from about 150 Nm to about 200 Nm.

In some embodiments, the reactor is a high-shear reactor, preferably an extruder, and wherein a torque of a motor of said high-shear reactor is from about 150 Nm to about 190 Nm.

In some embodiments, the reactor is a high-shear reactor, e.g., an extruder, preferably wherein the extruder operates with an RPM of between about 100 RPM and about 1200 RPM, more preferably between about 200 RPM and about 600 RPM.

In preferred embodiments, the reactor is a high-shear reactor, wherein said high-shear reactor operates with an RPM from about 200 RPM to about 400 RPM. In some embodiments, the reactor is a high-shear reactor, wherein said high-shear reactor operates with an RPM of about 200 RPM. In some embodiments, the reactor is a high-shear reactor, wherein said high-shear reactor operates with an RPM of about 250 RPM. In some embodiments, the reactor is a high-shear reactor, wherein said high-shear reactor operates with an RPM of about 300 RPM. In some embodiments, the reactor is a high-shear reactor, wherein said high-shear reactor operates with an RPM of about 350 RPM. In some embodiments, the reactor is a high-shear reactor, wherein said high-shear reactor operates with an RPM of about 400 RPM.

In some embodiments, the reactor is an extruder, preferably wherein the extruder operates with a feeding rate of the first lignin of about 10 to about 5000 kg/hr, more preferably about 50 kg/hr to about 2000 kg/h.

In some embodiments, the reactor is an extruder, preferably wherein the extruder operates with feeding rate of alcohol of about 1 kg/hr to about 300 kg/hr, more preferably about 5 kg/hr to about 150 kg/hr.

In some embodiments, the first lignin and the alcohol (preferably a diol) are reacted, preferably in one or more reactive zones of the reactor (preferably a high-shear reactor), for between about 2 seconds and about 20 minutes; at a temperature between about 50° C. and about 150° C.; at a pressure between about 1 bar (0.1 MPa) and about 5 bar (0.5 MPa). In some embodiments, the first lignin and the alcohol (preferably a diol) are reacted, preferably in one or more reactive zones of the reactor (preferably a high-shear reactor), for between about 2 seconds and about 20 minutes; at a temperature between about 50° C. and about 150° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin and the alcohol (preferably a diol) are reacted, preferably in one or more reactive zones of the reactor (preferably a high-shear reactor), for between about 3 seconds and about 5 minutes; at a temperature between about 50° C. and about 150° C.; at a pressure between about 1 bar (0.1 MPa) and about 5 bar (0.5 MPa). In some embodiments, the first lignin and the alcohol (preferably a diol) are reacted, preferably in one or more reactive zones of the reactor (preferably a high-shear reactor), for between about 3 seconds and about 5 minutes; at a temperature between about 70° C. and about 100° C.; at a pressure between about 1 bar (0.1 MPa) and about 5 bar (0.5 MPa).

In some embodiments, the first lignin and the alcohol (preferably a diol) are reacted, preferably in one or more reactive zones of the reactor (preferably a high-shear reactor), for between about 3 seconds and about 5 minutes; at a temperature between about 50° C. and about 150° C.; at a pressure between about 3 bar (0.3 MPa) and about 5 bar (0.5 MPa), preferably at a pressure between about 3 bar (0.3 MPa) and about 4 bar (0.4 MPa). In some embodiments, the first lignin and the alcohol (preferably a diol) are reacted, preferably in one or more reactive zones of the reactor (preferably a high-shear reactor), for between about 3 seconds and about 5 minutes; at a temperature between about 70° C. and about 100° C.; at a pressure between about 3 bar (0.3 MPa) and about 5 bar (0.5 MPa), preferably at a pressure between about 3 bar (0.3 MPa) and about 4 bar (0.4 MPa).

In some embodiments, the first lignin and the alcohol (preferably a diol) are reacted, preferably in one or more reactive zones of the reactor (preferably a high-shear reactor), for between about 3 seconds and about 5 minutes; at a temperature between about 70° C. and about 100° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin and the alcohol (preferably a diol) are reacted, preferably in one or more reactive zones of the reactor (preferably a high-shear reactor), for between about 3 seconds and about 5 minutes; at a temperature between about 70° C. and about 100° C.; at a pressure between about 3 bar (0.3 MPa) and about 5 bar (0.5 MPa), preferably at a pressure between about 3 bar (0.3 MPa) and about 4 bar (0.4 MPa); and the alcohol comprises between about 2% to about 60% of the total weight of the alcohol and first lignin; preferably about 5% to about 15% of the total weight of the alcohol and the first lignin.

In some embodiments, the first lignin is reacted, preferably in one or more reactive zones of the reactor (preferably a high-shear reactor), with diethylene glycol or PEG for between about 5 seconds and about 2 minutes; at a temperature between about 70° C. and about 100° C.; at a pressure between about 3 bar (0.3 MPa) and about 5 bar (0.5 MPa). In some embodiments, the first lignin is reacted, preferably in one or more reactive zones of the reactor (preferably a high-shear reactor), with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa); and the diethylene glycol or PEG comprises between about 2% to about 60% of the total weight of the alcohol and first lignin; preferably about 5% to about 15% of the total weight of the alcohol and the first lignin.

In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with the alcohol (preferably a diol) for between about 2 seconds and about 20 minutes, preferably about 5 minutes and about 2 minutes; at a temperature between about 50° C. and about 150° C.; at a pressure between about 1 bar (0.1 MPa) and about 5 bar (0.5 MPa). In some embodiments, the first lignin a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with the alcohol (preferably a diol) for between about 3 seconds and about 5 minutes; at a temperature between about 70° C. and about 100° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa). In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with an alcohol selected from diethylene glycol and PEG for between about 2 seconds and about 20 minutes, preferably about 5 seconds and about 2 minutes; at a temperature between about 50° C. and about 150° C.; at a pressure between about 1 bar (0.1 MPa) and about 5 bar (0.5 MPa). In some embodiments, the first lignin a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with diethylene glycol or PEG for between about 3 seconds and about 5 minutes; at a temperature between about 70° C. and about 100° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in one or more reactive zones of the reactor (preferably a high-shear reactor) with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa). In some embodiments, the first lignin is a pulping lignin, a hydrolytic lignin, a lignin fraction or a lignin derivative, preferably a lignosulphonate, a lignosulphonate fraction, a lignosulphonate derivative, a kraft lignin, a kraft lignin fraction, a kraft lignin derivative, a soda lignin, a soda lignin fraction, a soda lignin derivative, an organosolv lignin, an organosolv lignin fraction, and/or an organosolv lignin derivative; and is reacted in the reactive zone of an reactor with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin (i) is at least 70% pure as measured by Klason lignin; or (ii) has an aliphatic —OH content of at least 0.5 mmol/g; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa). In some embodiments, the first lignin (i) is at least 70% pure as measured by Klason lignin; or (ii) has an aliphatic —OH content of at least 0.5 mmol/g; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin (i) is at least 70% pure as measured by Klason lignin; or (ii) has an aliphatic —OH content of at least 0.5 mmol/g; and is reacted in one or more reactive zones of the reactor (preferably a high-shear reactor) with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa). In some embodiments, the first lignin (i) is at least 70% pure as measured by Klason lignin; or (ii) has an aliphatic —OH content of at least 0.5 mmol/g; and is reacted in one or more reactive zones of the reactor (preferably a high-shear reactor) with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with the alcohol (preferably a diol) for between about 2 seconds and about 20 minutes, preferably about 3 second and about 5 minutes; at a temperature between about 50° C. and about 150° C.; at a pressure between about 1 bar (0.1 MPa) and about 5 bar (0.5 MPa). In some embodiments, the first lignin a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with the alcohol (preferably a diol) for between about 3 seconds and about 5 minutes; at a temperature between about 70° C. and about 100° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa). In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with the alcohol (preferably a diol) for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with an alcohol selected from diethylene glycol and PEG for between about 2 seconds and about 20 minutes, preferably about 5 seconds and about 2 minutes; at a temperature between about 50° C. and about 150° C.; at a pressure between about 1 bar (0.1 MPa) and about 5 bar (0.5 MPa). In some embodiments, the first lignin a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with an alcohol selected from diethylene glycol and PEG for between about 3 seconds and about 5 minutes; at a temperature between about 70° C. and about 100° C.; at a pressure between about 1 bar (0.1 MPa) and about 5 bar (0.5 MPa); and the alcohol comprises between about 2% to about 60% of the total weight of the alcohol and first lignin; preferably about 5% to about 15% of the total weight of the alcohol and the first lignin.

In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa). In some embodiments, the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid or a combination thereof; and is reacted in one or more reactive zones of the reactor (preferably a high-shear reactor) with an alcohol selected from diethylene glycol and PEG for between about 5 seconds and about 2 minutes; at a temperature between about 70° C. and about 100° C.; at a pressure between about 3 bar (0.3 MPa) and about 5 bar (0.5 MPa); and the alcohol comprises between about 2% to about 60% of the total weight of the alcohol and first lignin; preferably about 5% to about 15% of the total weight of the alcohol and the first lignin.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

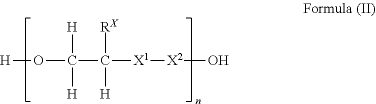

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa); and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

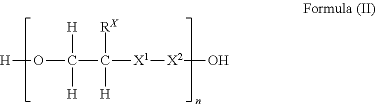

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa); and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa); and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa); and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

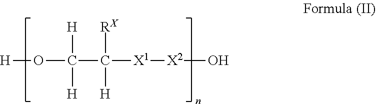

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

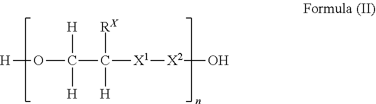

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II):

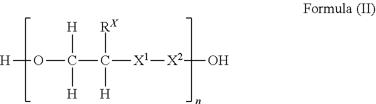

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.;
wherein a reaction time inside said high-shear reactor is from about 30 seconds to about 5 minutes; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is a diol of Formula (II):

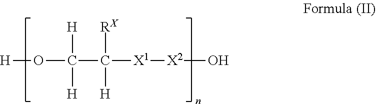

wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.;
wherein a reaction time inside said high-shear reactor is from about 30 seconds to about 5 minutes; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aromatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.;
wherein a reaction time inside said high-shear reactor is from about 30 seconds to about 5 minutes; and
wherein said second lignin is chemically modified by said diol.

In one aspect, the present invention provides a process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol;
wherein a shear stress inside said high-shear reactor is from about 100 N/m² to about 10,000 N/m²;
wherein a pressure inside said high-shear reactor is from about 1.1 bar (0.11 MPa) to about 20 bar (2.0 MPa), preferably from about 4 bar (0.4 MPa) to about 9 bar (0.9 MPa);
wherein a temperature inside said high-shear reactor is from about 70° C. to about 120° C.;
wherein a reaction time inside said high-shear reactor is from about 30 seconds to about 5 minutes; and
wherein said second lignin is chemically modified by said diol.

### EXAMPLES

The invention will now be illustrated by way of the following non-limiting examples. While particular embodiments of the invention are described below, a skilled person will appreciate that various changes and modifications can be made.

### Example 1: Evaluation of the Meltability with the Hot Plate Method

For characterising the meltability of lignin, DSC (differential scanning calorimetry) can be used to measure the glass transition temperature (T_{g}) of the lignin. However, DSC analysis can sometimes measure a glass transition temperature of a partially melting lignin, which does not account for the non-melting portion of the lignin.

For a more commercially relevant assessment of lignin melting, the inventors developed the Hot Plate Method, which consists of placing a sample of lignin on a hot plate at constant temperature. The temperature of the surface of the hot plate is measured using a special thermometer adapted for that purpose. The Hot Plate Method allows one to visually evaluate if a lignin is completely melted by evaluating the homogeneity of the melt by moving the melted product with a spatula. The Hot Plate Method also allows one to determine the time that a molten lignin stays molten, which is captured in the scale as described below.

To evaluate the melting characteristics of a sample, the sample (preferably about 70 mg of the sample) is placed on the hot plate at a constant temperature and triturated manually with an iron spatula. Preferably the sample is triturated with the spatula between 1 and 30 seconds. In a first embodiment of the Hot Plate Method, the melting characteristics of the lignin sample is observed visually and assigned a pre-determined value between 0 and 4 for each temperature of the hot plate. Thus, a particular sample of lignin can have different values for melting characteristics depending on the temperature of the hot plate.

The values correspond to the melting characteristics of the lignins as follows: 0 indicates no change; 1 indicates change of colour without melting; 2 indicates that the sample chars, i.e., turns completely black without melting; 3 indicates that the sample melts and stays melted on the hot plate for less than 30 seconds; 3.5 indicates that the sample melts and stays melted between 30 sec and 1 minute; 4 indicates the sample melts and stays melted for more than 1 minute.

In a second embodiment of the Hot Plate Method, the melting characteristics of the lignin sample is observed visually and assigned a pre-determined value between 0 and 5 for each temperature of the hot plate. Thus, a particular sample of lignin can have different values for melting characteristics depending on the temperature of the hot plate. The values correspond to the melting characteristics of the lignins as follows: 0 indicates no change; 1 indicates a change of color without melting; 2 indicates that the sample chars, i.e., turns completely black without melting; 3 indicates that the sample melts partially (the sample is either just softening or two clearly distinct phases of the melted and the not melted parts can be observed); 4 indicates the sample melts as a pasty liquid; 5 indicates the sample melts as a low viscosity liquid. Some lignins first do not melt, then turn brown, then melt partially and then turn into a black powder. This situation is noted as 0-3. Unless otherwise indicated, scores for various lignins under the Hot Plate Method refer to the second embodiment of the Hot Plate Method (i.e., 0-5 scale). The measurements of the Hot Plate Method are routinely carried out at 4 temperatures: 140° C., 160° C., 180° C., 210° C. Other temperatures are possible.

As used herein, a “melting lignin” refers to a lignin that obtains a score of 3 or higher by the first embodiment of the Hot Plate Method (0-4 scale), or a lignin that obtains a score of 4 or higher by the second embodiment of the Hot Plate Method (0-5 scale). A “partially melting lignin” refers to a lignin that obtains a score of 3 on the second embodiment of the Hot Plate Method (0-5 scale).

### A. Evaluation of the Commercial Lignin Before Treatment

PB 1000 commercial soda straw lignin obtained the following values under the first embodiment of the Hot Plate Method: 140° C.: (0); 160° C.: (0); 180° C.: (2); 210° C.: (3; Notes: sample changes colour and clumps quickly, starts out quite slimy, but gets harder and harder). The PB 1000 commercial soda straw lignin obtained the following values under the second embodiment of the Hot Plate Method: 140° C.: 0; 160° C.: 0; 180° C.: 3; 210° C.: 4.

B. Evaluation of the Treated Lignin from EXAMPLE 2

The lignin after treatment according to EXAMPLE 2 obtained the following values under the first embodiment of the Hot Plate Method: 140° C.: (3.5); 160° C.: (3.5); 180° C.: (4); 210° C.: (4). Notes: For all temperatures: Caramel consistency, peels off the plate and spoon very well.

C. Evaluation of the Treated Lignin from EXAMPLE 3

The lignin after treatment according to EXAMPLE 3 obtained the following values under the first Embodiment of the Hot Plate Method: 140° C.: (3, only partial melting, rubber consistency); 160° C.: (4); 180° C.: (4); 210° C.: (4). Notes: The tests from 160-210° C. showed liquid melting (complete low viscosity melting).

### Example 2: Reactive Extrusion of Soda Lignin with Diethylene Glycol

A melting lignin was produced with a Steer Omega 60 co-rotating double screw extruder by treating a commercial PB 1000 soda straw lignin with diethylene glycol (DEG) as the reactant. The shaft length of the extruder was 2640 mm, and the diameter was 59.7 mm. The extruder screw is shown in FIG. 2. The screw extruder comprised 9 zones. The lignin was introduced in the main feeder at the beginning of zone 1. The reactant (DEG) was pumped with a liquid dosing pump at the beginning of zone 6. The operational parameters were the following: Torque of the motor 168-178 Nm; screw speed 398 RPM; feeding rate of main feeder 113 kg/h; total feeding rate 124.3 kg/h; feeding rate of DEG 11.3 kg/h; dosage of the reactant (on total weight) 10.02 (w %); Specific energy 0.142-0.150 kWh/kg; melt pressure at the end of the extruder (die) 4-5 bar. The temperatures in the different zones were the following: zone 1, not heated; zone 2, 55° C.; zone 3, 60° C.; zone 4, 60° C.; zone 5, 65° C.; zone 6, 65° C.; zone 7, 72° C.; zone 8, 76° C.; zone 9, 85° C.; die inside, 90° C. The lignin entered as a powder and came out as a liquid which was cooled until solidification and subsequently ground to a powder.

The melting characteristics of the untreated lignin according to the Hot Plate Method (second embodiment) were the following: 140° C.: 0; 160° C.: 0; 180° C.: 3; 210° C.: 4. The melting characteristics of the reacted lignin according to the Hot Plate Method were the following: 140° C.: 0; 160° C.: 4; 180° C.: 5; 210° C.: 5.

The amounts of OH groups in the lignins were determined with ³¹P NMR realized by BOKU University in Vienna. The untreated lignin had 2.28 mmol/g (1) of aliphatic OH and 2.86 mmol/g (2) of phenolic OH. The reacted lignin had 2.92 mmol/g (3) of aliphatic OH and 2.12 mmol/g (4) of phenolic OH. The molar mass of the reactant is 106.12 g/mol (5) and its number of OH is 2 (6). Calculation of the yields of the reaction was as follows:

$$Aliphatic OH from the lignin : 89.8 \% * ( 1 ) = 2.05 mmol / g ; \qquad ( 7 )$$

$$Aliphatic OH from the reactant : 1 / ( 5 ) * 1000 * ( 6 ) = 1.89 mmol / g ; \qquad ( 8 )$$

$$Aliphatic OH present before the reaction = ( 7 ) + ( 8 ) = 3.94 mmol / g ; \qquad ( 9 )$$

$$Reacted aliphatic OH = ( 9 ) - ( 3 ) = 1.02 mmol / g ; \qquad ( 10 )$$

Percentage of the reactant's OH that has reacted with the aliphatic OH of the lignin=(10)/(8)*100/2=27.0% (the factor ½ is because the reaction consumes 2 OH groups)

$$Phenolic OH from the lignin : 89.8 \% * ( 2 ) = 2.57 mmol / g ; \qquad ( 11 )$$

The comparison of (11) to (4) shows that 0.45 mmol/g (12) of phenolic OH of the lignin has reacted with the aliphatic OH of the reactant.

This corresponds to (12)/(8)*100=24.0%.

The total aliphatic OH of the reactant that has reacted is 27.0%+24.0%=51.0%

### Example 3: Reactive Extrusion of Soda Lignin with Peg 400

The same experimental setup as in EXAMPLE 2 was tested also on a commercial PB 1000 soda straw lignin with PEG 400 as the alcohol. The operational parameters were the following: Torque of the motor 175-185 Nm; screw speed 347 RPM; feeding rate of main feeder 116 kg/h; feeding rate of PEG 400 11.6 kg/h; Specific energy 0.162-0.187 kWh/kg; melt pressure at the end of the extruder (die) 3-4 bar (0.3-0.4 Pa). The temperatures in the different zones were the following: zone 1, 38-40° C.; zone 2, 55° C.; zone 3, 60° C.; zone 4, 60° C.; zone 5, 65° C.; zone 6, 68° C.; zone 7, 74° C.; zone 8, 78° C.; zone 9, 85° C.; die inside, 90° C.; die outside, 105-110° C. The lignin entered as a powder and came out as a liquid which was cooled until solidification and subsequently ground to a powder.

### Example 4: Reactive Extrusion of Soda Lignin with Ethylene Glycol

The same experimental setup as in EXAMPLE 2 is tested on a commercial PB 1000 soda straw lignin with ethylene glycol as the reactant.

The reactant is pumped with a liquid dosing pump at the beginning of zone 3. The operational parameters are the following: Torque of the motor 117-133 Nm; screw speed 400 RPM; total feeding rate 82.4 kg/h; dosage of the reactant (on total weight) 9.95 (w %); melt pressure at the end of the extruder (die) 5-6 bar (0.5-0.6 MPa). The temperatures in the different zones are the following: zone 1, not heated; zone 2, 55° C.; zone 3, 61° C.; zone 4, 63° C.; zone 5, 65° C.; zone 6, 65° C.; zone 7, 68° C.; zone 8, 73° C.; zone 9, 86° C.; die inside, 84° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 4; 160° C.: 5; 180° C.: 5; 210° C.: 5.

As determined with ³¹P NMR, the untreated lignin has 1.98 mmol/g of aliphatic OH and 2.86 mmol/g of phenolic OH. The reacted lignin has 3.15 mmol/g of aliphatic OH and 1.75 mmol/g of phenolic OH. The molar mass of the reactant is 62.068 g/mol and it has 2 OH groups. A calculation similar to the one demonstrated in EXAMPLE 2 yields a percentage of the reactant's OH that undergoes a chemical reaction with the aliphatic OH groups of the lignin, amounting to 28.7%. Similarly, the levels of phenolic OH groups results in a difference of 0.83 mmol/g of phenolic OH which corresponds to 25.7% of the reactant's OH reacting with the phenolic OH groups of the lignin. In total 54.4% of the reactant's OH react.

### Example 5: Reactive Extrusion of Soda Lignin with Propylene Glycol

The same experimental setup as in EXAMPLE 2 is tested on a commercial PB 1000 soda straw lignin with propylene glycol as the reactant.

The reactant is pumped with a liquid dosing pump at the beginning of zone 3. The operational parameters are the following: Torque of the motor 140-153 Nm; screw speed 400 RPM; total feeding rate 87.64 kg/h; dosage of the reactant (on total weight) 9.97 (w %); melt pressure at the end of the extruder (die) 6-7 bar (0.6-0.7 MPa). The temperatures in the different zones are the following: zone 1, not heated; zone 2, 55° C.; zone 3, 60° C.; zone 4, 61° C.; zone 5, 64° C.; zone 6, 65° C.; zone 7, 68° C.; zone 8, 75° C.; zone 9, 82° C.; die inside, 83° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 5; 210° C.: 5.

As determined with ³¹P NMR, the untreated lignin has 1.98 mmol/g of aliphatic OH and 2.86 mmol/g of phenolic OH. The reacted lignin has 2.86 mmol/g of aliphatic OH and 2.03 mmol/g of phenolic OH. The molar mass of the reactant is 76.095 g/mol and it has 2 OH groups. A calculation similar to the one demonstrated in EXAMPLE 2 yields a percentage of the reactant's OH that undergoes a chemical reaction with the aliphatic OH groups of the lignin, amounting to 29.4%. Similarly, the levels of phenolic OH groups result in a difference of 0.54 mmol/g of phenolic OH which corresponds to 20.8% of the reactant's OH reacting with the phenolic OH groups of the lignin. In total 50.2% of the reactant's OH react.

### Example 6: Reactive Extrusion of Soda Lignin with Dipropylene Glycol

The same experimental setup as in EXAMPLE 2 is tested on a commercial PB 1000 soda straw lignin with dipropylene glycol as the reactant.

The reactant is pumped with a liquid dosing pump at the beginning of zone 3. The operational parameters are the following: Torque of the motor 133-165 Nm; screw speed 400 RPM; total feeding rate 86.48 kg/h; dosage of the reactant (on total weight) 10.04 (w %); melt pressure at the end of the extruder (die) 6-9 bar. The temperatures in the different zones are the following: zone 1, not heated; zone 2, 53° C.; zone 3, 61° C.; zone 4, 65° C.; zone 5, 65° C.; zone 6, 68° C.; zone 7, 70° C.; zone 8, 75° C.; zone 9, 82° C.; die inside, 83° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 5; 180° C.: 5; 210° C.: 5.

As determined with ³¹P NMR, the untreated lignin has 1.98 mmol/g of aliphatic OH and 2.86 mmol/g of phenolic OH. The reacted lignin has 2.05 mmol/g of aliphatic OH and 2.14 mmol/g of phenolic OH. The molar mass of the reactant is 134.173 g/mol and it has 2 OH groups. A calculation similar to the one demonstrated in EXAMPLE 2 yields a percentage of the reactant's OH that undergoes a chemical reaction with the aliphatic OH groups of the lignin, amounting to 41.0%. Similarly, the levels of phenolic OH groups result in a difference of 0.43 mmol/g of phenolic OH which corresponds to 28.9% of the reactant's OH reacting with the phenolic OH groups of the lignin. In total 69.9% of the reactant's OH react.

### Example 7: Reactive Extrusion of Soda Lignin with Polypropylene Glycol 400

The same experimental setup as in EXAMPLE 2 is tested on a commercial PB 1000 soda straw lignin with polypropylene glycol 400 (PPG 400) as the reactant.

The reactant is pumped with a liquid dosing pump at the beginning of zone 3. The operational parameters are the following: Torque of the motor 133-165 Nm; screw speed 400 RPM; total feeding rate 88.4 kg/h; dosage of the reactant (on total weight) 10.41 (w %); melt pressure at the end of the extruder (die) 6-9 bar. The temperatures in the different zones are the following: zone 1, not heated; zone 2, 53° C.; zone 3, 58° C.; zone 4, 60° C.; zone 5, 62° C.; zone 6, 65° C.; zone 7, 68° C.; zone 8, 76° C.; zone 9, 87° C.; die inside, 85° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 5; 210° C.: 5.

As determined with ³¹P NMR, the untreated lignin has 1.98 mmol/g of aliphatic OH and 2.86 mmol/g of phenolic OH. The reacted lignin has 2.05 mmol/g of aliphatic OH and 2.14 mmol/g of phenolic OH. The molar mass of the reactant is 400 g/mol and it has 2 OH groups. A calculation similar to the one demonstrated in EXAMPLE 2 yields a percentage of the reactant's OH that has undergone a chemical reaction with the aliphatic OH groups of the lignin, amounting to 41.0%. Similarly, the levels of phenolic OH groups result in a difference of 0.43 mmol/g of phenolic OH which corresponds to 28.9% of the reactant's OH reacting with the phenolic OH groups of the lignin. In total 69.9% of the reactant's OH react.

### Example 8: Reactive Extrusion of Soda Lignin with Polyethylene Glycol 400 at 80° C. and 347 RPM

The same experimental setup as in EXAMPLE 2 was tested on a commercial PB 1000 soda straw lignin with polyethylene glycol 400 (PEG 400) as the reactant.

The operational parameters were the following: Torque of the motor 175-185 Nm; screw speed 347 RPM; total feeding rate 124.3 kg/h; dosage of the reactant (on total weight) 10.02 (w %); melt pressure at the end of the extruder (die) 4-6 bar (0.4-0.6 MPa). The temperatures in the different zones were the following: zone 1, not heated; zone 2, 55° C.; zone 3, 60° C.; zone 4, 60° C.; zone 5, 65° C.; zone 6, 68° C.; zone 7, 74° C.; zone 8, 78° C.; zone 9, 85° C.; die inside, 90° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 0-3; 160° C.: 4; 180° C.: 4; 210° C.: 5.

As determined with ³¹P NMR, the untreated lignin had 2.02 mmol/g of aliphatic OH and 2.86 mmol/g of phenolic OH. The reacted lignin had 1.87 mmol/g of aliphatic OH and 2.44 mmol/g of phenolic OH. The molar mass of the reactant is 400 g/mol and it has 2 OH groups. A calculation similar to the one demonstrated in EXAMPLE 2 yielded a percentage of the reactant's OH that has undergone a chemical reaction with the aliphatic OH groups of the lignin, amounting to 44.8%. Similarly, the levels of phenolic OH groups resulted in a difference of 0.13 mmol/g of phenolic OH which corresponded to 27.0% of the reactant's OH reacted with the phenolic OH groups of the lignin. In total 71.8% of the reactant's OH have reacted.

### Example 9: Reactive Extrusion of Soda Lignin with Polyethylene Glycol 400 at 100° C. and 400 RPM

The same experimental setup as in EXAMPLE 2 was tested on a commercial PB 1000 soda straw lignin with polyethylene glycol 400 (PEG 400) as the reactant.

The operational parameters were the following: Torque of the motor 71-136 Nm; screw speed 400 RPM; total feeding rate 86.2 kg/h; dosage of the reactant (on total weight) 7.19 (w %); melt pressure at the end of the extruder (die) 4-6 bar (0.4-0.6 MPa). The temperatures in the different zones were the following: zone 1, not heated; zone 2, 88° C.; zone 3, 100° C.; zone 4, 94° C.; zone 5, 78° C.; zone 6, 96° C.; zone 7, 116° C.; zone 8, 78° C.; zone 9, 115° C.; die inside, 100° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 3; 160° C.: 4; 180° C.: 4; 210° C.: 5.

As determined with ³¹P NMR, the untreated lignin had 2.24 mmol/g of aliphatic OH and 2.67 mmol/g of phenolic OH. The reacted lignin had 2.08 mmol/g of aliphatic OH and 2.34 mmol/g of phenolic OH. The molar mass of the reactant is 400 g/mol and it has 2 OH groups. A calculation similar to the one demonstrated in EXAMPLE 2 yielded a percentage of the reactant's OH that has undergone a chemical reaction with the aliphatic OH groups of the lignin, amounting to 49.8%. Similarly, the levels of phenolic OH groups resulted in a difference of 0.14 mmol/g of phenolic OH which corresponded to 38.4% of the reactant's OH reacted with the phenolic OH groups of the lignin. In total 88.2% of the reactant's OH have reacted.

### Example 10: Reactive Extrusion of Soda Lignin with Polyethylene Glycol 400 at 100° C. and 200 RPM

The same experimental setup as in EXAMPLE 2 was tested on a commercial PB 1000 soda straw lignin with polyethylene glycol 400 (PEG 400) as the reactant.

The operational parameters were the following: Torque of the motor 35-37 Nm; screw speed 200 RPM; total feeding rate 86.2 kg/h; dosage of the reactant (on total weight) 7.19 (w %); melt pressure at the end of the extruder (die) 3-4 bar (0.3-0.4 MPa). The temperatures in the different zones were the following: zone 1, not heated; zone 2, 55° C.; zone 3, 60° C.; zone 4, 60° C.; zone 5, 68° C.; zone 6, 65° C.; zone 7, 98° C.; zone 8, 76° C.; zone 9, 106° C.; die inside, 100° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 3; 160° C.: 4; 180° C.: 4; 210° C.: 5.

As determined with ³¹P NMR, the untreated lignin had 2.24 mmol/g of aliphatic OH and 2.67 mmol/g of phenolic OH. The reacted lignin had 2.29 mmol/g of aliphatic OH and 2.36 mmol/g of phenolic OH. The molar mass of the reactant is 400 g/mol and it has 2 OH groups. A calculation similar to the one demonstrated in EXAMPLE 2 yielded a percentage of the reactant's OH that has undergone a chemical reaction with the aliphatic OH groups of the lignin, amounting to 20.7%. Similarly, the levels of phenolic OH groups resulted in a difference of 0.12 mmol/g of phenolic OH which corresponded to 32.8% of the reactant's OH reacted with the phenolic OH groups of the lignin. In total 53.5% of the reactant's OH have reacted.

### Example 11: Reactive Extrusion of Soda Lignin with 1,4-Butanediol

The same experimental setup as in EXAMPLE 2 is tested on a commercial PB 1000 soda straw lignin with 1,4-butanediol as the reactant. This is an example of aliphatic diols with only C-atoms in the aliphatic part.

The reactant is pumped with a liquid dosing pump at the beginning of zone 3. The operational parameters are the following: Torque of the motor 130-146 Nm; screw speed 400 RPM; total feeding rate 87.4 kg/h; dosage of the reactant (on total weight) 10.78 (w %); melt pressure at the end of the extruder (die) 4-9 bar. The temperatures in the different zones are the following: zone 1, not heated; zone 2, 55° C.; zone 3, 60° C.; zone 4, 63° C.; zone 5, 64° C.; zone 6, 66° C.; zone 7, 70° C.; zone 8, 75° C.; zone 9, 84° C.; die inside, 85° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 5; 210° C.: 5.

As determined with ³¹P NMR, the untreated lignin has 1.98 mmol/g of aliphatic OH and 2.86 mmol/g of phenolic OH. The reacted lignin has 2.14 mmol/g of aliphatic OH and 2.01 mmol/g of phenolic OH. The molar mass of the reactant is 90.12 g/mol and it has 2 OH groups. A calculation similar to the one demonstrated in EXAMPLE 2 yields a percentage of the reactant's OH that undergoes a chemical reaction with the aliphatic OH groups of the lignin, amounting to 42.2%. Similarly, the levels of phenolic OH groups result in a difference of 0.54 mmol/g of phenolic OH which corresponds to 22.7% of the reactant's OH reacting with the phenolic OH groups of the lignin. In total 64.9% of the reactant's OH react.

### Example 12: Reactive Extrusion of Soda Lignin with Glycerol

The same experimental setup as in EXAMPLE 2 is tested on a commercial PB 1000 soda straw lignin with glycerol as the reactant.

The reactant is pumped with a liquid dosing pump at the beginning of zone 3. The operational parameters are the following: Torque of the motor 102-115 Nm; screw speed 400 RPM; total feeding rate 69 kg/h; dosage of the reactant (on total weight) 5.8 (w %); melt pressure at the end of the extruder (die) 5-8 bar (0.5-0.8 MPa). The temperatures in the different zones are the following: zone 1, not heated; zone 2, 55° C.; zone 3, 63° C.; zone 4, 65° C.; zone 5, 75° C.; zone 6, 65° C.; zone 7, 69° C.; zone 8, 75° C.; zone 9, 83° C.; die inside, 85° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 0; 210° C.: 0. The melting characteristics of the reacted lignin according to the Hot Plate Method are the following: 140° C.: 3; 160° C.: 4; 180° C.: 5; 210° C.: 5.

As determined with ³¹P NMR, the untreated lignin has 1.98 mmol/g of aliphatic OH and 2.56 mmol/g of phenolic OH. The reacted lignin has 2.40 mmol/g of aliphatic OH and 2.14 mmol/g of phenolic OH. The molar mass of the reactant is 92.094 g/mol and it has 3 OH groups. A calculation similar to the one demonstrated in EXAMPLE 2 yields a percentage of the reactant's OH that undergoes a chemical reaction with the aliphatic OH groups of the lignin, amounting to 39.1%. Similarly, the levels of phenolic OH groups result in a difference of 0.27 mmol/g of phenolic OH which corresponds to 14.4% of the reactant's OH reacting with the phenolic OH groups of the lignin. In total 53.5% of the reactant's OH react.

### Example 13: Reactive Extrusion of Soda Lignin with Resorcinol

The same experimental setup as in EXAMPLE 2 is tested on a commercial PB 1000 soda straw lignin with resorcinol as the reactant. This is an example of aromatic diols.

The reactant is blended with the lignin in an external blending installation and then introduced in the main feeder. The operational parameters are the following: Torque of the motor 125-136 Nm; screw speed 400 RPM; total feeding rate 85.4 kg/h; dosage of the reactant (on total weight) 9.60 (w %); melt pressure at the end of the extruder (die) 5-8 bar (0.5-0.8 MPa). The temperatures in the different zones are the following: zone 1, not heated; zone 2, 54° C.; zone 3, 62° C.; zone 4, 63° C.; zone 5, 66° C.; zone 6, 68° C.; zone 7, 70° C.; zone 8, 76° C.; zone 9, 83° C.; die inside, 86° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 5; 210° C.: 5.

As determined with ³¹P NMR, the untreated lignin has 1.98 mmol/g of aliphatic OH and 2.86 mmol/g of phenolic OH. The reacted lignin has 1.21 mmol/g of aliphatic OH and 2.75 mmol/g of phenolic OH. The molar mass of the reactant is 90.12 g/mol and it has 2 OH groups. A calculation similar to the one demonstrated in EXAMPLE 2 yields a percentage of the reactant's OH that undergoes a chemical reaction with the aliphatic OH groups of the lignin, amounting to 33.3%. Similarly, the levels of phenolic OH groups result in a difference of 1.58 mmol/g of phenolic OH. But for this calculation the reacted aliphatic OH (0.58 mmol/g) and the not reacted resorcinol OH (0.58 mmol/g) have to be deducted from the difference which results in a value of 0.42 mmol/g. This corresponds to 23.8% of the reactant's OH reacting with the phenolic OH groups of the lignin. In total 57.1% of the reactant's OH react.

### Example 14: Reactive Extrusion of Soda Lignin with Polyethylene Glycol 400 at 120° C.

The same experimental setup as in EXAMPLE 2 was tested on a commercial PB 1000 soda straw lignin with polyethylene glycol 400 (PEG 400) as the reactant at higher temperatures.

The operational parameters were the following: Torque of the motor 97-116 Nm; screw speed 257 RPM; total feeding rate 71 kg/h; dosage of the reactant (on total weight) 9.15 (w %); melt pressure at the end of the extruder (die) 3-4 bar (0.3-0.4 MPa). The temperatures in the different zones were the following: zone 1, not heated; zone 2, 90° C.; zone 3, 103° C.; zone 4, 114° C.; zone 5, 111° C.; zone 6, 115° C.; zone 7, 122° C.; zone 8, 125° C.; zone 9, 124° C.; die inside, 110° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 3; 160° C.: 4; 180° C.: 5; 210° C.: 5.

As determined with ³¹P NMR, the untreated lignin had 2.27 mmol/g of aliphatic OH and 2.76 mmol/g of phenolic OH. The reacted lignin had 2.02 mmol/g of aliphatic OH and 2.44 mmol/g of phenolic OH. The molar mass of the reactant is 400 g/mol and it has 2 OH groups. A calculation similar to the one demonstrated in EXAMPLE 2 yielded a percentage of the reactant's OH that had undergone a chemical reaction with the aliphatic OH groups of the lignin, amounting to 54.6%. Similarly, the levels of phenolic OH groups resulted in a difference of 0.07 mmol/g of phenolic OH which corresponded to 14.7% of the reactant's OH reacted with the phenolic OH groups of the lignin. In total 69.3% of the reactant's OH reacted.

### Example 15: Reactive Extrusion of Soda Lignin with Polyethylene Glycol 400 at 150° C.

The same experimental setup as in EXAMPLE 2 was tested on a commercial PB 1000 soda straw lignin with polyethylene glycol 400 (PEG 400) as the reactant at even higher temperatures.

The operational parameters were the following: Torque of the motor 78-110 Nm; screw speed 257 RPM; total feeding rate 71 kg/h; dosage of the reactant (on total weight) 9.15 (w %); melt pressure at the end of the extruder (die) 2-3 bar (0.2-0.3 MPa). The temperatures in the different zones were the following: zone 1, not heated; zone 2, 102° C.; zone 3, 103° C.; zone 4, 125° C.; zone 5, 135° C.; zone 6, 140° C.; zone 7, 142° C.; zone 8, 146° C.; zone 9, 150° C.; die inside, 146° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 3; 160° C.: 4; 180° C.: 5; 210° C.: 5.

As determined with ³¹P NMR, the untreated lignin had 2.27 mmol/g of aliphatic OH and 2.76 mmol/g of phenolic OH. The reacted lignin had 2.08 mmol/g of aliphatic OH and 2.46 mmol/g of phenolic OH. The molar mass of the reactant is 400 g/mol and it has 2 OH groups. A calculation similar to the one demonstrated in EXAMPLE 2 yielded a percentage of the reactant's OH that had undergone a chemical reaction with the aliphatic OH groups of the lignin, amounting to 48.10%. Similarly, the levels of phenolic OH groups resulted in a difference of 0.05 mmol/g of phenolic OH which corresponded to 10.3% of the reactant's OH reacted with the phenolic OH groups of the lignin. In total 58.4% of the reactant's OH reacted.

### Example 16: Reactive Extrusion of Kraft Hardwood Lignin with Polyethylene Glycol 400

The same experimental setup as in EXAMPLE 2 was tested on a commercial PB KW Kraft hardwood lignin with polyethylene glycol 400 (PEG 400) as the reactant.

The operational parameters were the following: Torque of the motor 101-119 Nm; screw speed 251 RPM; total feeding rate 79.24 kg/h; dosage of the reactant (on total weight) 9.14 (w %); melt pressure at the end of the extruder (die) 8-12 bar (0.8-1.2 MPa). The temperatures in the different zones were the following: zone 1, not heated; zone 2, 55° C.; zone 3, 70° C.; zone 4, 65° C.; zone 5, 65° C.; zone 6, 65° C.; zone 7, 65° C.; zone 8, 101° C.; zone 9, 86° C.; die inside, 80° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 3; 210° C.: 4. The melting characteristics of the reacted lignin according to the Hot Plate Method were the following: 140° C.: 4; 160° C.: 5; 180° C.: 5; 210° C.: 5.

As determined with ³¹P NMR, the untreated lignin had 1.27 mmol/g of aliphatic OH and 4.45 mmol/g of phenolic OH. The reacted lignin had 1.54 mmol/g of aliphatic OH and 3.96 mmol/g of phenolic OH. The molar mass of the reactant is 400 g/mol and it has 2 OH groups. A calculation similar to the one demonstrated in EXAMPLE 2 yielded a percentage of the reactant's OH that had undergone a chemical reaction with the aliphatic OH groups of the lignin, amounting to 7.7%. Similarly, the levels of phenolic OH groups resulted in a difference of 0.08 mmol/g of phenolic OH which corresponded to 18.3% of the reactant's OH reacted with the phenolic OH groups of the lignin. In total 26.0% of the reactant's OH have reacted.

### Example 17: Reactive Extrusion of Kraft Softwood Lignin with Polyethylene Glycol 400

The same experimental setup as in EXAMPLE 2 was tested on a commercial Biopiva 100 Kraft softwood lignin with polyethylene glycol 400 (PEG 400) as the reactant.

The operational parameters were the following: Torque of the motor 86-95 Nm; screw speed 200 RPM; total feeding rate 81.4 kg/h; dosage of the reactant (on total weight) 9.09 (w %); melt pressure at the end of the extruder (die) 4-6 bar (0.4-0.6 MPa). The temperatures in the different zones were the following: zone 1, not heated; zone 2, 55° C.; zone 3, 60° C.; zone 4, 59° C.; zone 5, 67° C.; zone 6, 75° C.; zone 7, 95° C.; zone 8, 101° C.; zone 9, 104° C.; die inside, 95° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 0; 210° C.: 3. The melting characteristics of the reacted lignin according to the Hot Plate Method were the following: 140° C.: 0; 160° C.: 3; 180° C.: 3; 210° C.: 4.

As determined with ³¹P NMR, the untreated lignin had 2.11 mmol/g of aliphatic OH and 4.16 mmol/g of phenolic OH. The reacted lignin had 2.29 mmol/g of aliphatic OH and 3.68 mmol/g of phenolic OH. The molar mass of the reactant is 400 g/mol and it has 2 OH groups. A calculation similar to the one demonstrated in EXAMPLE 2 yields a percentage of the reactant's OH that has undergone a chemical reaction with the aliphatic OH groups of the lignin, amounting to 9.10%. Similarly, the levels of phenolic OH groups resulted in a difference of 0.10 mmol/g of phenolic OH which corresponds to 22.4% of the reactant's OH reacted with the phenolic OH groups of the lignin. In total 31.5% of the reactant's OH reacted.

### Example 18: Reactive Extrusion of Kraft Softwood Lignin with Polyethylene Glycol 400 at Higher Pressure and Higher Torque

The same experimental setup as in EXAMPLE 2 was tested on a commercial Biopiva 100 Kraft softwood lignin with polyethylene glycol 400 (PEG 400) as the reactant.

The operational parameters were the following: Torque of the motor 143-164 Nm; screw speed 300 RPM; total feeding rate 54.65 kg/h; dosage of the reactant (on total weight) 13.08 (w %); melt pressure at the end of the extruder (die) 7 bar (0.7 MPa). The temperatures in the different zones were the following: zone 1, not heated; zone 2, 55° C.; zone 3, 87° C.; zone 4, 61° C.; zone 5, 75° C.; zone 6, 69° C.; zone 7, 72° C.; zone 8, 112° C.; zone 9, 86° C.; die inside, 90° C. The lignin entered as a powder and came out as a liquid which was cooled until solidification and subsequently ground to a powder.

The melting characteristics of the untreated lignin according to the Hot Plate Method were the following: 140° C.: 0; 160° C.: 0; 180° C.: 0; 210° C.: 3. The melting characteristics of the reacted lignin according to the Hot Plate Method were the following: 140° C.: 3; 160° C.: 4; 180° C.: 4; 210° C.: 4.

As determined with ³¹P NMR, the untreated lignin had 2.11 mmol/g of aliphatic OH and 4.16 mmol/g of phenolic OH. The reacted lignin had 1.94 mmol/g of aliphatic OH and 3.42 mmol/g of phenolic OH. The molar mass of the reactant is 400 g/mol and it has 2 OH groups. A calculation similar to the one demonstrated in EXAMPLE 2 yielded a percentage of the reactant's OH that had undergone a chemical reaction with the aliphatic OH groups of the lignin, amounting to 41.9%. Similarly, the levels of phenolic OH groups resulted in a difference of 0.20 mmol/g of phenolic OH which corresponded to 29.9% of the reactant's OH reacted with the phenolic OH groups of the lignin. In total 71.8% of the reactant's OH reacted.

### Example 19: Reactive Extrusion of Kraft Straw Lignin with Polyethylene Glycol 400

The same experimental setup as in EXAMPLE 2 was tested on a commercial PB KWS Kraft straw lignin with polyethylene glycol 400 (PEG 400) as the reactant.

The operational parameters were the following: Torque of the motor 90-114 Nm; screw speed 400 RPM; total feeding rate 142.5 kg/h; dosage of the reactant (on total weight) 8.77 (w %); melt pressure at the end of the extruder (die) 4-8 bar (0.4-0.8 MPa). The temperatures in the different zones were the following: zone 1, not heated; zone 2, 55° C.; zone 3, 62° C.; zone 4, 62° C.; zone 5, 107° C.; zone 6, 66° C.; zone 7, 66° C.; zone 8, 106° C.; zone 9, 85° C.; die inside, 83° C. The lignin entered as a powder and came out as a liquid which was cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 5; 210° C.: 5.

As determined with ³¹P NMR, the untreated lignin had 2.08 mmol/g of aliphatic OH and 2.89 mmol/g of phenolic OH. The reacted lignin had 1.90 mmol/g of aliphatic OH and 2.61 mmol/g of phenolic OH. The molar mass of the reactant is 400 g/mol and it has 2 OH groups. A calculation similar to the one demonstrated in EXAMPLE 2 yields a percentage of the reactant's OH that has undergone a chemical reaction with the aliphatic OH groups of the lignin, amounting to 49.7%. Similarly, the levels of phenolic OH groups resulted in a difference of 0.03 mmol/g of phenolic OH which corresponds to 6.0% of the reactant's OH reacted with the phenolic OH groups of the lignin. In total 55.7% of the reactant's OH reacted.

### Example 20: Reactive Extrusion of Soda Bagasse Lignin with Polyethylene Glycol 400

The same experimental setup as in EXAMPLE 2 is tested on a Soda bagasse lignin with polyethylene glycol 400 (PEG 400) as the reactant. The lignin is precipitated from black liquor from Quimpac, Peru with sulfuric acid at pH 2.5.

The operational parameters are the following: Torque of the motor 120-150 Nm; screw speed 400 RPM; total feeding rate 87.64 kg/h; dosage of the reactant (on total weight) 10.20 (w %); melt pressure at the end of the extruder (die) 7-9 bar (0.7-0.9 MPa). The temperatures in the different zones are the following: zone 1, not heated; zone 2, 54° C.; zone 3, 58° C.; zone 4, 62° C.; zone 5, 65° C.; zone 6, 70° C.; zone 7, 73° C.; zone 8, 75° C.; zone 9, 85° C.; die inside, 85° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 4; 160° C.: 5; 180° C.: 5; 210° C.: 5.

As determined with ³¹P NMR, the untreated lignin has 2.03 mmol/g of aliphatic OH and 2.54 mmol/g of phenolic OH. The reacted lignin has 1.95 mmol/g of aliphatic OH and 2.11 mmol/g of phenolic OH. The molar mass of the reactant is 400 g/mol and it has 2 OH groups. A calculation similar to the one demonstrated in EXAMPLE 2 yields a percentage of the reactant's OH that undergoes a chemical reaction with the aliphatic OH groups of the lignin, amounting to 37.5%. Similarly, the levels of phenolic OH groups result in a difference of 0.17 mmol/g of phenolic OH which corresponds to 33.5% of the reactant's OH reacting with the phenolic OH groups of the lignin. In total 71.0% of the reactant's OH react.

### Example 21: Reactive Extrusion of Lignosulfonate with Polyethylene Glycol 400

The same experimental setup as in EXAMPLE 2 is tested on a commercial lignosulfonate from Larochette Vernizel with polyethylene glycol 400 (PEG 400) as the reactant.

The operational parameters are the following: Torque of the motor 140-158 Nm; screw speed 400 RPM; total feeding rate 86.4 kg/h; dosage of the reactant (on total weight) 9.03 (w %); melt pressure at the end of the extruder (die) 5-9 bar (0.5-0.9 MPa). The temperatures in the different zones are the following: zone 1, not heated; zone 2, 55° C.; zone 3, 60° C.; zone 4, 62° C.; zone 5, 64° C.; zone 6, 65° C.; zone 7, 68° C.; zone 8, 75° C.; zone 9, 85° C.; die inside, 86° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 3; 160° C.: 4; 180° C.: 4; 210° C.: 5.

As determined with ³¹P NMR, the untreated lignin has 2.46 mmol/g of aliphatic OH and 0.96 mmol/g of phenolic OH. The reacted lignin has 2.24 mmol/g of aliphatic OH and 0.83 mmol/g of phenolic OH. The molar mass of the reactant is 400 g/mol and it has 2 OH groups. A calculation similar to the one demonstrated in EXAMPLE 2 yields a percentage of the reactant's OH that undergoes a chemical reaction with the aliphatic OH groups of the lignin, amounting to 49.8%. Similarly, the levels of phenolic OH groups result in a difference of 0.04 mmol/g of phenolic OH which corresponds to 9.6% of the reactant's OH reacting with the phenolic OH groups of the lignin. In total 59.4% of the reactant's OH react.

### Example 22: Reactive Extrusion of Hydrolytic Lignin with Polyethylene Glycol 400

The same experimental setup as in EXAMPLE 2 is tested on a hydrolytic lignin from the company Graanul with polyethylene glycol 400 (PEG 400) as the reactant.

The operational parameters are the following: Torque of the motor 125-155 Nm; screw speed 400 RPM; total feeding rate 88.4 kg/h; dosage of the reactant (on total weight) 10.07 (w %); melt pressure at the end of the extruder (die) 6-9 bar (0.6-0.9 MPa). The temperatures in the different zones are the following: zone 1, not heated; zone 2, 54° C.; zone 3, 58° C.; zone 4, 64° C.; zone 5, 65° C.; zone 6, 65° C.; zone 7, 68° C.; zone 8, 76° C.; zone 9, 84° C.; die inside, 83° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 0-3; 160° C.: 3; 180° C.: 4; 210° C.: 5.

As determined with ³¹P NMR, the untreated lignin has 4.73 mmol/g of aliphatic OH and 1.67 mmol/g of phenolic OH. The reacted lignin has 4.15 mmol/g of aliphatic OH and 1.43 mmol/g of phenolic OH. The molar mass of the reactant is 400 g/mol and it has 2 OH groups. A calculation similar to the one demonstrated in EXAMPLE 2 yields a percentage of the reactant's OH that undergoes a chemical reaction with the aliphatic OH groups of the lignin, amounting to 60.3%. Similarly, the levels of phenolic OH groups result in a difference of 0.07 mmol/g of phenolic OH which corresponds to 14.3% of the reactant's OH reacting with the phenolic OH groups of the lignin. In total 74.6% of the reactant's OH react.

### Example 23: Reactive Extrusion of Alcell Organosolv Lignin with Polyethylene Glycol 400

The same experimental setup as in EXAMPLE 2 is tested on Alcell hardwood Organosolv lignin from the company Repap with polyethylene glycol 400 (PEG 400) as the reactant.

The operational parameters are the following: Torque of the motor 138-159 Nm; screw speed 400 RPM; total feeding rate 89.4 kg/h; dosage of the reactant (on total weight) 10.07 (w %); melt pressure at the end of the extruder (die) 6-9 bar (0.6-0.9 MPa). The temperatures in the different zones are the following: zone 1, not heated; zone 2, 55° C.; zone 3, 60° C.; zone 4, 65° C.; zone 5, 70° C.; zone 6, 70° C.; zone 7, 75° C.; zone 8, 78° C.; zone 9, 81° C.; die inside, 84° C. The lignin enters as a powder and comes out as a liquid which is cooled until solidification and subsequently ground to a powder.

The melting characteristics of the untreated lignin according to the Hot Plate Method are the following: 140° C.: 0; 160° C.: 0; 180° C.: 3; 210° C.: 4. The melting characteristics of the reacted lignin according to the Hot Plate Method are the following: 140° C.: 4; 160° C.: 5; 180° C.: 5; 210° C.: 5.

As determined with ³¹P NMR, the untreated lignin has 1.39 mmol/g of aliphatic OH and 2.71 mmol/g of phenolic OH. The reacted lignin has 1.62 mmol/g of aliphatic OH and 2.36 mmol/g of phenolic OH. The molar mass of the reactant is 400 g/mol and it has 2 OH groups. A calculation similar to the one demonstrated in EXAMPLE 2 yields a percentage of the reactant's OH that undergoes a chemical reaction with the aliphatic OH groups of the lignin, amounting to 13.3%. Similarly, the levels of phenolic OH groups result in a difference of 0.08 mmol/g of phenolic OH which corresponds to 15.3% of the reactant's OH reacting with the phenolic OH groups of the lignin. In total 28.6% of the reactant's OH react.

### Example 24: The Melting is Improved by the Reaction as Compared to the Pure Plasticizing Effect of the Reactant

The goal of this example is to show that the reaction with the lignin's OH results in a better melting behavior than the one that is achieved only by mixing the reactant with the lignin without reaction (plasticizing effect).

For this purpose, lignin was mixed in the laboratory with the same dosage as in the corresponding high-shear reactor, and the resulting blend was subjected to a Hot Plate Melting test (second embodiment). The result of this test is compared to the result obtained after the chemical reaction in the extruder (i.e., high-shear reactor).

All of the above extrusion reactions show such an improvement of the melting behavior. The following list shows the most representative examples.
1. In EXAMPLE 9 the melting characteristics of the sample that was not reacted, only blended in the laboratory (plasticizing effect) according to the Hot Plate Method were the following: 140° C.: 0-3; 160° C.: 3; 180° C.: 3; 210° C.: 4. The melting characteristics of the reacted lignin of Example 9 according to the Hot Plate Method were the following: 140° C.: 3; 160° C.: 4; 180° C.: 4; 210° C.: 5.
2. The melting characteristics of the reacted and unreacted sample of EXAMPLE 10 were identical to EXAMPLE 9.
3. In EXAMPLE 14 the melting characteristics of the sample that is not reacted, only blended in the laboratory (plasticizing effect) according to the Hot Plate Method were the following: 140° C.: 0; 160° C.: 3; 180° C.: 4; 210° C.: 5. The melting characteristics of the reacted lignin of Example 14 according to the Hot Plate Method were the following: 140° C.: 3; 160° C.: 4; 180° C.: 5; 210° C.: 5.
4. The melting characteristics of the reacted and unreacted sample of EXAMPLE 15 were identical to EXAMPLE 14.
5. In EXAMPLE 16 the melting characteristics of the sample that is not reacted only blended in the laboratory (plasticizing effect) according to the Hot Plate Method were the following: 140° C.: 0; 160° C.: 4; 180° C.: 5; 210° C.: 5. The melting characteristics of the reacted lignin of Example 16 according to the Hot Plate Method were the following: 140° C.: 4; 160° C.: 5; 180° C.: 5; 210° C.: 5. This is despite of the low reaction rate.
6. In EXAMPLE 18 the melting characteristics of the sample that was not reacted, only blended in the laboratory (plasticizing effect) according to the Hot Plate Method were the following: 140° C.: 0; 160° C.: 3; 180° C.: 4; 210° C.: 5. The melting characteristics of the reacted lignin of Example 18 according to the Hot Plate Method were the following: 140° C.: 3; 160° C.: 4; 180° C.: 4; 210° C.: 5.
7. In EXAMPLE 19 the melting characteristics of the sample that was not reacted only blended in the laboratory (plasticizing effect) according to the Hot Plate Method were the following: 140° C.: 0; 160° C.: 0; 180° C.: 3; 210° C.: 5. The melting characteristics of the reacted lignin of Example 19 according to the Hot Plate Method were the following: 140° C.: 3; 160° C.: 4; 180° C.: 5; 210° C.: 5. In this case the melting temperature has been lowered by 40° C. by the reaction.

1. A process for modifying the melting characteristics of a first lignin, wherein the first lignin is a partially meltable lignin, a meltable lignin, or wherein the first lignin can be plasticized to become a partially meltable lignin or a meltable lignin; the process comprising:
reacting said first lignin with a diol in a high-shear reactor to produce a second lignin;
wherein said diol is an aliphatic diol, an aromatic diol, or a diol of Formula (II): 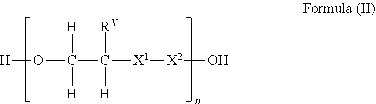
wherein:
X¹ is independently, at each occurrence, selected from a chemical bond and —CHR^{X1}—;
X² is independently, at each occurrence, selected from a chemical bond and —CHR^{X2}—;
R^{X} is independently, at each occurrence, selected from —H, —C₁-C₄ alkyl and —OH;
R^{X1} is independently, at each occurrence, selected from —H, —C₁-C₄ alkyl and —OH;
R^{X2} is independently, at each occurrence, selected from —H, —C₁-C₄ alkyl and —OH; and
n is any integer from 1 to 10,000;
wherein said second lignin is chemically modified by said diol.

2. The process of claim 1, wherein the high-shear reactor is a screw reactor or a screw extruder, preferably wherein said high-shear reactor is a twin-screw extruder.

3. The process of any of the preceding claims, wherein said modifying the melting characteristics of the first lignin comprises (i) lowering the melting temperature of the first lignin; (ii) converting a partially meltable first lignin to a completely meltable second lignin; and/or (iii) reducing the melting viscosity of the first lignin.

4. The process of any of the preceding claims, wherein said chemical modification of said second lignin by said diol comprises etherification of said first lignin by said diol to produce an etherified second lignin.

5. The process of any of the preceding claims, wherein said first lignin and said diol are reacted in one or more reactive zones of said high shear reactor for about 2 seconds to about 20 minutes, preferably from about 30 seconds to about 5 minutes.

6. The process of any of the preceding claims, wherein the first lignin and the diol are reacted in the high-shear reactor at a temperature from about 50° C. to about 200° C.; preferably from about 70° C. to about 120° C.

7. The process of any of the preceding claims, wherein the first lignin and the diol are reacted in the high-shear reactor at a pressure from about 1.1 bar (0.11 MPa) to about 20 bar (2.0 MPa), preferably at a pressure from about 4 bar (0.4 MPa) to about 9 bar (0.9 MPa).

8. The process of any of the preceding claims, wherein the first lignin and the diol are reacted in the high-shear wherein the shear stress inside said high-shear reactor is from about 100 N/m² to about 10,000 N/m².

9. The process of any of the preceding claims, wherein a hydroxyl group of said first lignin has not been previously chemically modified by reaction with a diol, preferably an aliphatic diol, an aromatic diol, or a diol of Formula (II); more preferably a diol of Formula II.

10. The process of any of the preceding claims, wherein at least 10% of the diol chemically reacts with the first lignin.

11. The process of any of the preceding claims, wherein the diol comprises between about 2% to about 60% of the total weight of the diol and first lignin; preferably about 5% to about 15% of the total weight of the diol and the first lignin.

12. The process of any of the preceding claims, wherein the diol is a diol of Formula (II).

13. The process of any of the preceding claims, wherein the first lignin is produced by separation of crude lignin from lignocellulose or by an additional process step on crude lignin to produce a lignin fraction or a lignin derivative, preferably wherein the separation process is a pulping process or a hydrolytic process, more preferably a kraft process producing kraft lignin, a soda process producing soda lignin, an organosolv process producing organosolv lignin or a sulphite process producing lignosulphonates.

14. The process of any of claims 1-13, wherein the first lignin is produced by extraction of the soluble fraction of a hydrolytic lignin with an extraction solvent, preferably wherein the extraction solvent is also used for the pulping of lignin, preferably wherein the extraction solvent is aqueous sodium hydroxide or ethanol.

15. The process of any of the preceding claims, wherein the first lignin (i) is at least 70% pure as measured by Klason lignin; or (ii) has an aliphatic —OH content of at least 0.5 mmol/g.

16. The process of any of the preceding claims, wherein the first lignin is a plasticized lignin prepared by combining a crude lignin with a plasticizer, preferably wherein the plasticizer is PEGDM 250, PEGDM 500, ethylene carbonate, propylene carbonate, caprolactone, 1,4-diazabicyclo (2,2,2) octane, vanillin, acetosyringone, acetovanillone, ferulic acid, homovanilic acid, adipic acid, lactic acid, succinic acid, glycerol, or a combination thereof.

17. The process of any of the preceding claims, wherein the diol is selected from an aromatic diol, an aliphatic diol, a polyol, and a polyglycol; preferably wherein the aliphatic diol is selected from mono ethylene glycol, 1,3-propanediol, 1,4-butanediol, 1,5-pentanediol, and 1,6-hexanediol; preferably wherein the polyglycol is glycerol; and preferably wherein the polyglycol is selected from diethylene glycol, triethylene glycol, tetraethylene glycol, pentaethylene glycol, hexaethylene glycol, polyethylene glycol, or polypropylene glycol, more preferably wherein said polyethylene glycol has a molecular weight of about 400 g/mol, 800 g/mol or 1200 g/mol, and wherein said polypropylene glycol has a molecular weight of about 400 g/mol, 725 g/mol, 1,000 g/mol, or 2,000 g/mol; or a combination thereof.

18. A modified lignin, produced by a process according to any one of claims 1-17, comprising a structural unit of the formula: 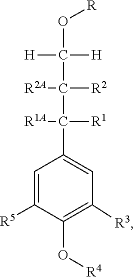
wherein:
R is selected from C₁-C₂₀ alkyl, —(CHR^{A}—CHR^{B}—O)ₙ—H, and C₆-C₁₄ aryl, wherein each alkyl or aryl is optionally substituted by one or more —OH;
n is an integer from 1 to 10,000;
R^{A} and R^{B} are each independently H or C₁-C₆ alkyl;
R^{1A} is H and R¹ is independently selected from —H, —OH, —O-lignin polymer residue, lignin polymer residue, and a carbohydrate; or R^{1A} and R¹ combine together with the carbon atom to which they are attached to form a carbonyl group;
R^{2A} is H and R² is independently selected from —H, —OH, —SH, —O-lignin polymer residue, lignin polymer residue, and a carbohydrate; or R^{2A} and R² combine together with the carbon atom to which they are attached to form a carbonyl group;
R³ is independently selected from —H, —OCH₃, and lignin polymer residue;
R⁴ is independently selected from —H and lignin polymer residue; and
R⁵ is independently selected from —H, —OCH₃, and lignin polymer residue.

19. A modified lignin produced by a process according to any one of claims 1-17.
